(19) United States
(12) Patent Application Publication
(10) Pub. No.: US 2008/0112009 A1
(43) Pub. Date: May 15, 2008

(54) IMAGE PROCESSING APPARATUS, LOG RECORDING METHOD, AND STORAGE MEDIUM

(76) Inventor: Yoshiharu TOJO, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/936,408

(22) Filed: Nov. 7, 2007

(30) Foreign Application Priority Data
Nov. 15, 2006 (JP) 2006-309435
Oct. 24, 2007 (JP) 2007-276732

(51) Int. Cl. G06F 15/00

(52) U.S. Cl. 358/1.15

(57) ABSTRACT

An image processing apparatus where an application level function is implemented by one or more basic functions is disclosed. The disclosed image processing apparatus includes a log recording unit configured to record basic function logs of the basic functions according to log formats of the basic functions, the basic function logs being associated with an application level function log of the application level function.

### BACKGROUND OF THE INVENTION

1. Field of the Invention

The present invention generally relates to a technique of recording logs in an image processing apparatus such as a multifunction printer (MFP).

2. Description of the Related Art

Image processing apparatuses such as MFPs generally have a function to record various types of logs used, for example, to monitor usage of users or for accounting.

FIG. 1 shows exemplary software architecture of a conventional MFP. In the conventional MFP, software components are categorized into an application layer including applications representing tasks to be performed by users and a service layer including services for controlling hardware components. Each application in the application layer performs its task by using a combination of services in the service layer and sends a log including results of the services to a log manager to record the log. The number of applications or document input/output tasks (copying, printing, etc.) in the conventional MFP is limited to five to ten, and a log format is defined for each of the tasks.

FIG. 2 shows exemplary log formats in the conventional MFP. In FIG. 2, exemplary formats of the following logs are shown: a copy log, a scanning-storing log, a stored document printing log, a PC document printing log, a fax receiving-printing log, a fax transmission log, and a scanning-delivery log. Each format includes information indicating its log type: “copy” for the copy log, “scanning-storing” for the scanning-storing log, “stored document printing” for the stored document printing log, “PC document printing” for the PC document printing log, “fax receiving-printing” for the fax receiving-printing log, “fax transmission” for the fax transmission log, and “scanning-delivery” for the scanning delivery log. Referring back to FIG. 1, a copy application records a copy log when copying a document; a printing application records a stored document printing log when printing a stored document or records a PC document printing log when printing a PC document; a fax application records a fax receiving-printing log when receiving a fax or records a fax transmission log when sending a fax; and a scanning application records a scanning-storing log when scanning and storing a document or records a scanning-delivery log when scanning and delivering a document.

Also, patent document 1 discloses another software architecture for recording and transferring logs.

[Patent document 1] Japanese Patent Application Publication No. 2006-107217

Meanwhile, an MFP employing software architecture different from that shown in FIG. 1 has been proposed. In the software architecture of the proposed MFP, software components are categorized into an activity group including activities that correspond to applications or application level functions in the conventional MFP described above; and a filter group including filters representing basic functions or functional units that are smaller than activities. The proposed MFP allows the user to compose an activity by combining filters and thereby to flexibly add application level functions.

FIG. 3 shows the software architecture of the proposed MFP in which each activity in the activity group is composed of a combination of filters in the filter group. For example, a copy activity is composed of a scanning filter and a printing filter.

Allowing users to add activities or application level functions may increase the security risks, and therefore it is all the more important to record logs in the proposed MFP.

One problem in recording logs in the proposed MFP is that since it allows users to compose new activities by combining filters, the number of necessary log formats increases and a program for recording logs becomes complicated if logs are recorded in the same manner as in the conventional MFP.

FIG. 4 shows exemplary log formats defined in the same manner as in the conventional MFP. Assuming that the proposed MFP includes four input filters (e.g. scanning, stored document input, PC document input, and fax reception) and four output filters (e.g. printing, email transmission, document storage, and fax transmission), the number of necessary log formats (or combinations of input and output filters) becomes 4×4=16.

The proposed MFP also enables outputting a document by multiple output filters (multiple output) and combining documents input from multiple input filters (multiple input). In this case, the number of filter combinations, i.e., the number of necessary log formats increases further.

FIG. 5 shows another exemplary log format defined in the same manner as in the conventional MFP. Assuming that up to four input filters and up to four output filters can be selected, the number of filter combinations or the number of necessary log formats becomes 225:

(combinations of input filters)×(combinations of output filters)

(₄C₄+₄C₃+₄C₂+₄C₁)×(₄C₄+₄C₃+₄C₂+₄C₁)=15×15=225

Further, the proposed MFP enables downloading new filters from a server in a network and installing the downloaded filters. This leads to another problem in recording logs. That is, if the activities in the proposed MFP are configured to record logs of filters in substantially the same manner as the applications record logs of services in the conventional MFP, the activities cannot record logs of new filters (downloaded filters) since there is no way for them to know the contents or formats of logs generated by the new filters.

### SUMMARY OF THE INVENTION

Embodiments of the present invention provide an image processing apparatus, a log recording method, and a storage medium containing program code for causing a computer to perform the log recording method that solve or reduce one or more problems caused by the limitations and disadvantages of the related art.

An embodiment of the present invention provides an image processing apparatus where an application level function is implemented by one or more basic functions. The image processing apparatus includes a log recording unit configured to record basic function logs of the basic functions according to log formats of the basic functions, the basic function logs being associated with an application level function log of the application level function.

Another embodiment of the present invention provides a method for recording logs in an image processing apparatus where an application level function is implemented by one or more basic functions. The method includes the step of recording basic function logs of the basic functions according to log formats of the basic functions, the basic function logs being associated with an application level function log of the application level function.

Still another embodiment of the present invention provides a storage medium having program code stored therein for causing a computer controlling an image processing apparatus, in which an application level function is implemented by one or more basic functions, to record basic function logs of the basic functions according to log formats of the basic functions, the basic function logs being associated with an application level function log of the application level function.

### BRIEF DESCRIPTION OF THE DRAWINGS

FIG. 1 is a drawing illustrating exemplary software architecture of a conventional MFP;

FIG. 2 is a drawing illustrating exemplary log formats in the conventional MFP;

FIG. 3 is a drawing illustrating exemplary software architecture of another MFP;

FIG. 4 is a drawing illustrating exemplary log formats defined in the same manner as in the conventional MFP;

FIG. 5 is a drawing illustrating another exemplary log format defined in the same manner as in the conventional MFP;

FIG. 6 is a block diagram illustrating a configuration of an exemplary MFP according to an embodiment of the present invention;

FIG. 7 is a block diagram illustrating another configuration of the exemplary MFP according to an embodiment of the present invention;

FIGS. 8A and 8B are drawings illustrating exemplary log formats;

FIG. 9 is a drawing illustrating a format of a log type field;

FIG. 10 is a drawing illustrating exemplary software architecture for recording logs according to an embodiment of the present invention;

FIG. 11 is a drawing illustrating another exemplary software architecture for recording logs according to an embodiment of the present invention;

FIGS. 12A and 12B are drawings illustrating exemplary log recording settings and an interface for making the log recording settings;

FIGS. 13A and 13B are drawings illustrating other exemplary log recording settings and an interface for making the log recording settings;

FIGS. 14A and 14B are drawings illustrating other exemplary log recording settings and an interface for making the log recording settings;

FIGS. 15A through 15C are drawings illustrating still other exemplary log recording settings and interfaces for making the log recording settings;

FIG. 16 is a sequence chart showing an exemplary log recording process;

FIG. 17 is a sequence chart showing another exemplary log recording process;

FIG. 18 is a sequence chart showing another exemplary log recording process;

FIG. 19 is a sequence chart showing another exemplary log recording process;

FIG. 20 is a sequence chart showing an exemplary log displaying process;

FIGS. 21A through 21C are drawings illustrating exemplary screens for displaying logs;

FIGS. 22A and 22B are drawings illustrating other exemplary log formats;

FIG. 23 is a drawing illustrating linked logs;

FIG. 24 is a drawing illustrating still another exemplary software architecture for recording logs; and

FIG. 25 is a sequence chart showing still another exemplary log recording process.

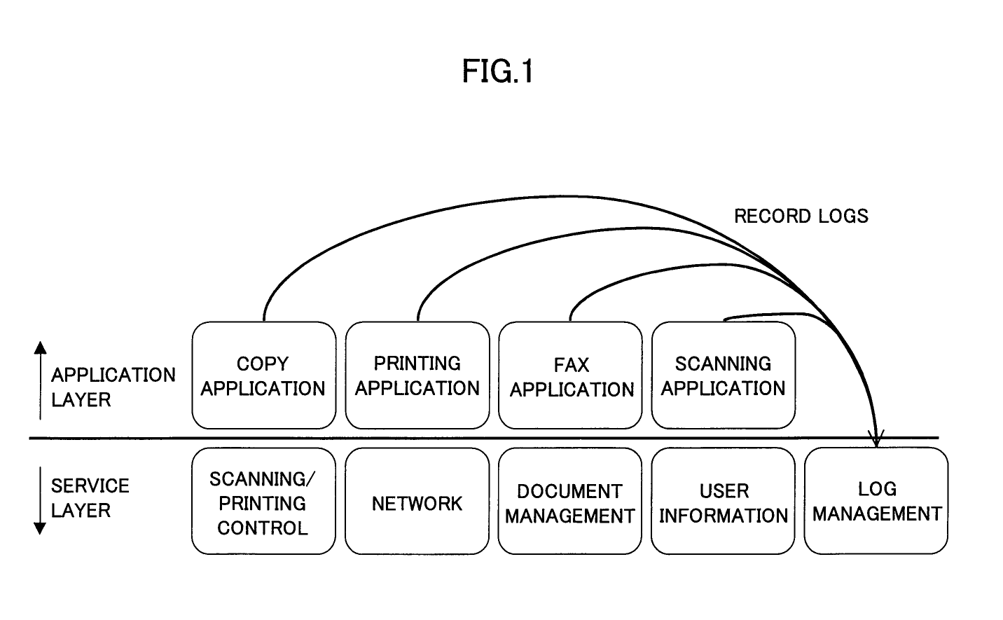

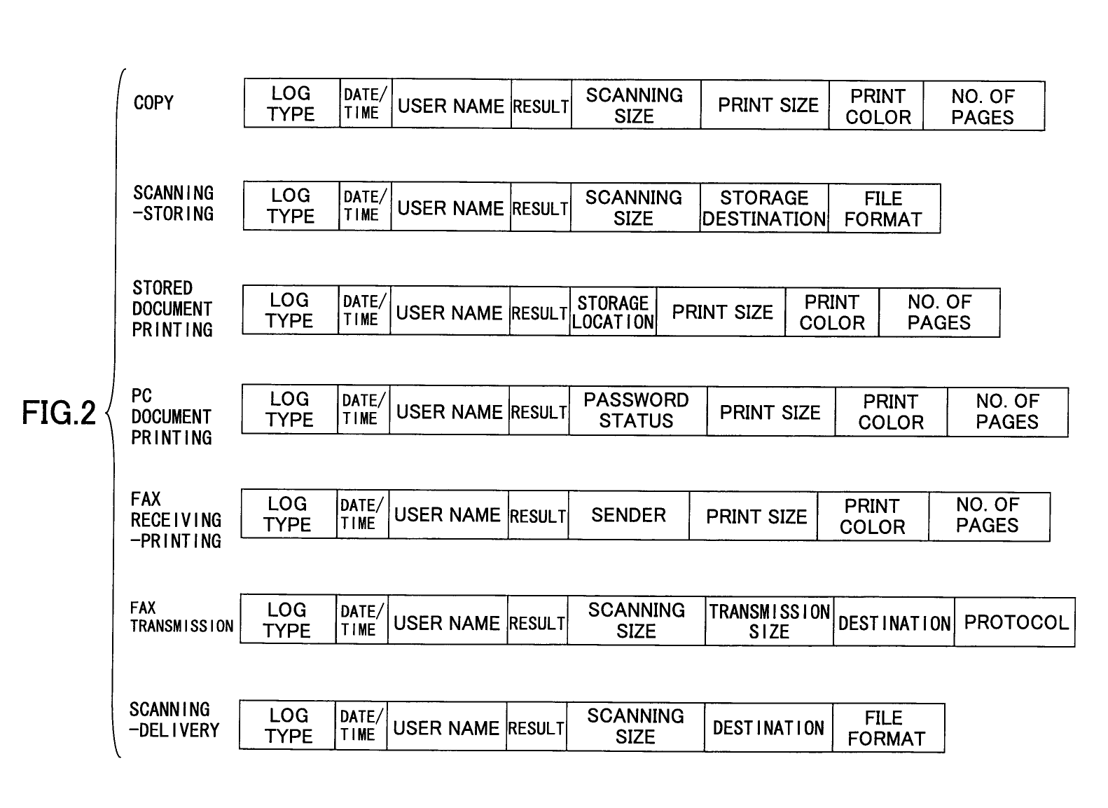

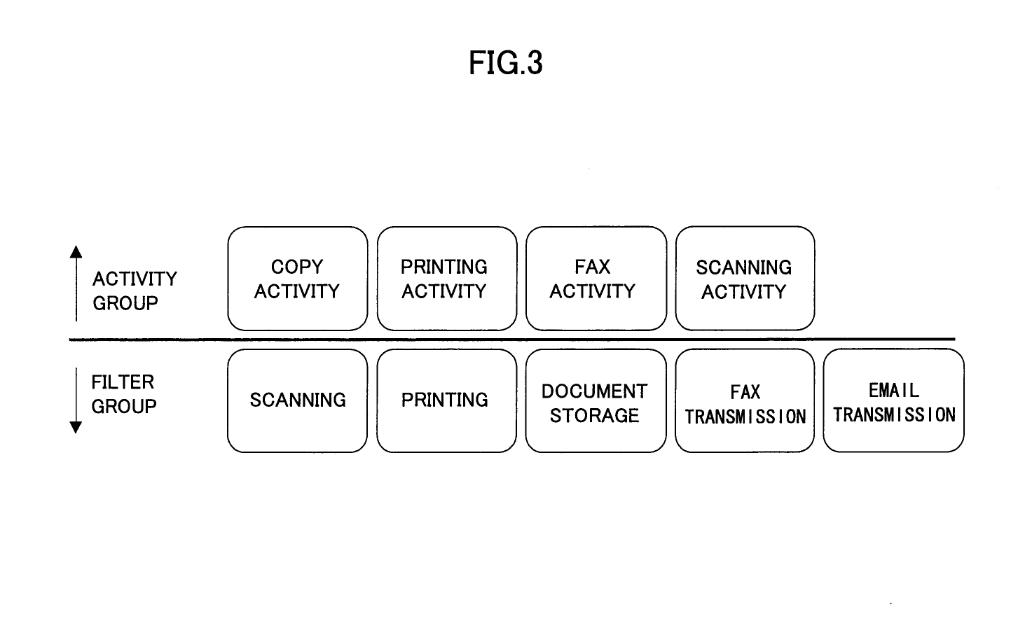

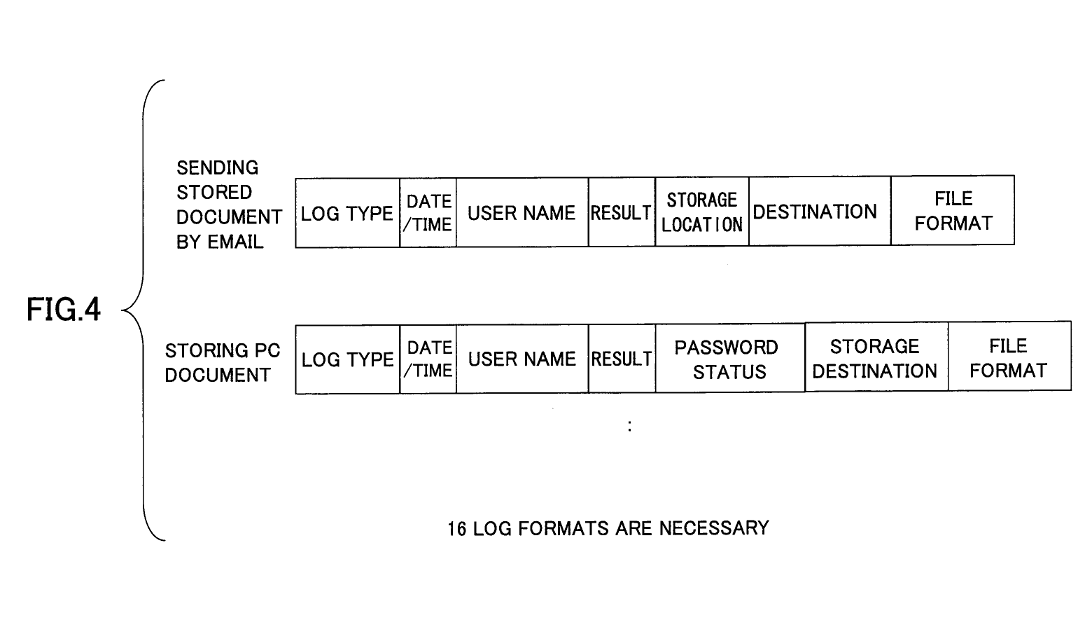

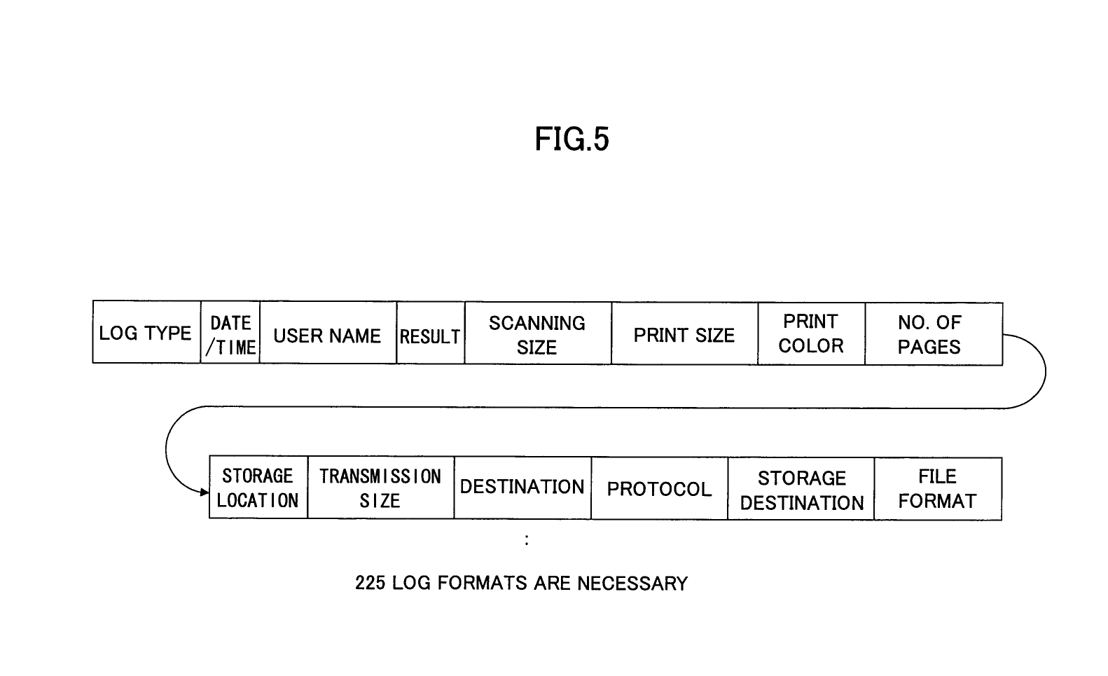

### DESCRIPTION OF THE PREFERRED EMBODIMENTS

Preferred embodiments of the present invention are described below with reference to the accompanying drawings.

### <System Configuration>

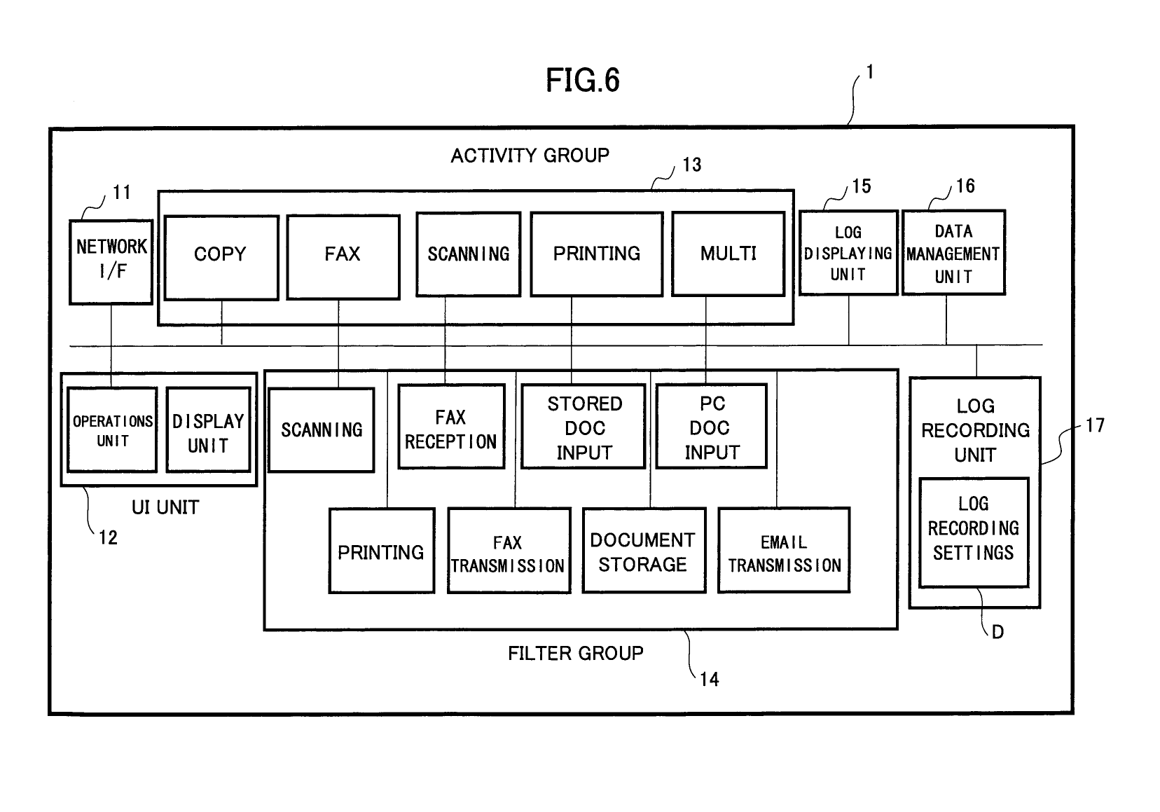

FIG. 6 is a block diagram illustrating a configuration of an MFP 1 according to an embodiment of the present invention.

As shown in FIG. 6, the MFP 1 includes a network interface (I/F) 11 for connecting the MFP 1 to a network, a user interface (UI) unit 12 including an operations unit used by users to operate the MFP 1 and a display unit for displaying information, an activity group 13 including activities, and a filter group 14 including filters. Filters represent basic functions of the MFP 1 and activities represent application level functions or tasks performed by users. Each activity is composed of one or more filters. For example, a copy activity performs a process of copying a document and provides screens necessary for the process; a fax activity performs a process of scanning a document and faxing the scanned document, and provides screens necessary for the process; and a multi-activity allows a user to specify and execute any combination of filters and provides necessary screens.

The MFP 1 also includes a log displaying unit 15 for processing logs to display them in a user-friendly manner, a data management unit 16 for storing logs in a storage unit such as a hard disk drive (HDD), and a log recording unit 17 for recording logs (or for causing the data management unit 16 to store logs). The log recording unit 17 includes log recording settings D. The log recording settings D include settings for specifying filters whose logs are to be recorded and settings for specifying, by security levels, logs to be recorded. The log recording settings D are described later in more detail.

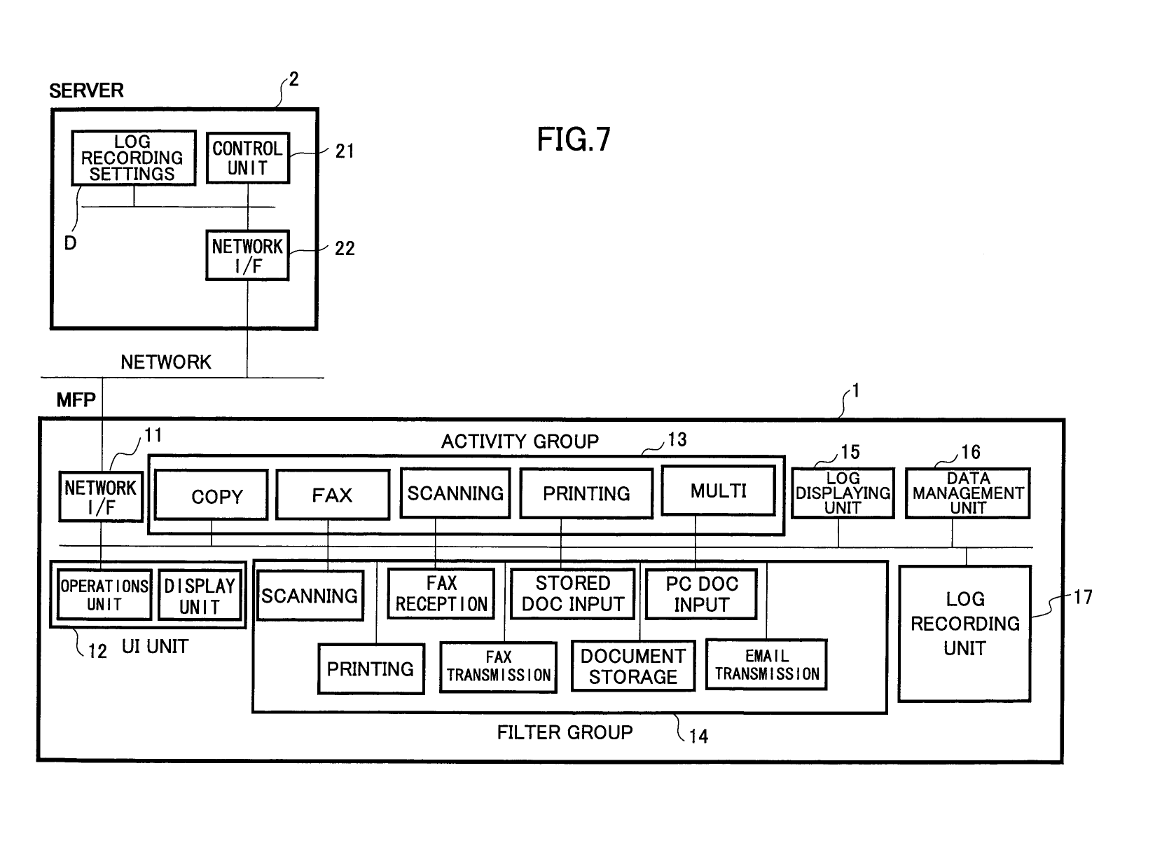

FIG. 7 shows another configuration of the MFP 1 according to an embodiment of the present invention. In the configuration shown in FIG. 7, the log recording settings D are stored in a server 2 connected via a network to the MFP 1 instead of in the log recording unit 17. The server 2 includes a control unit 21 for controlling other components in the server 2 and a network I/F 22 for connecting the server 2 to a network.

This configuration makes it possible for multiple MFPs to share a set of log recording settings and thereby makes it easier to maintain log recording settings. In other words, this configuration makes it possible to centrally manage log recording settings of multiple MFPs in an organizational unit such as a department or a company.

### <Log Formats>

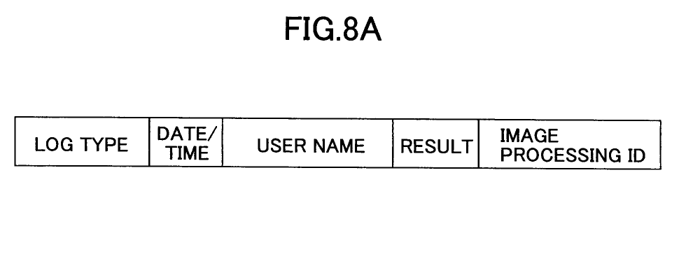

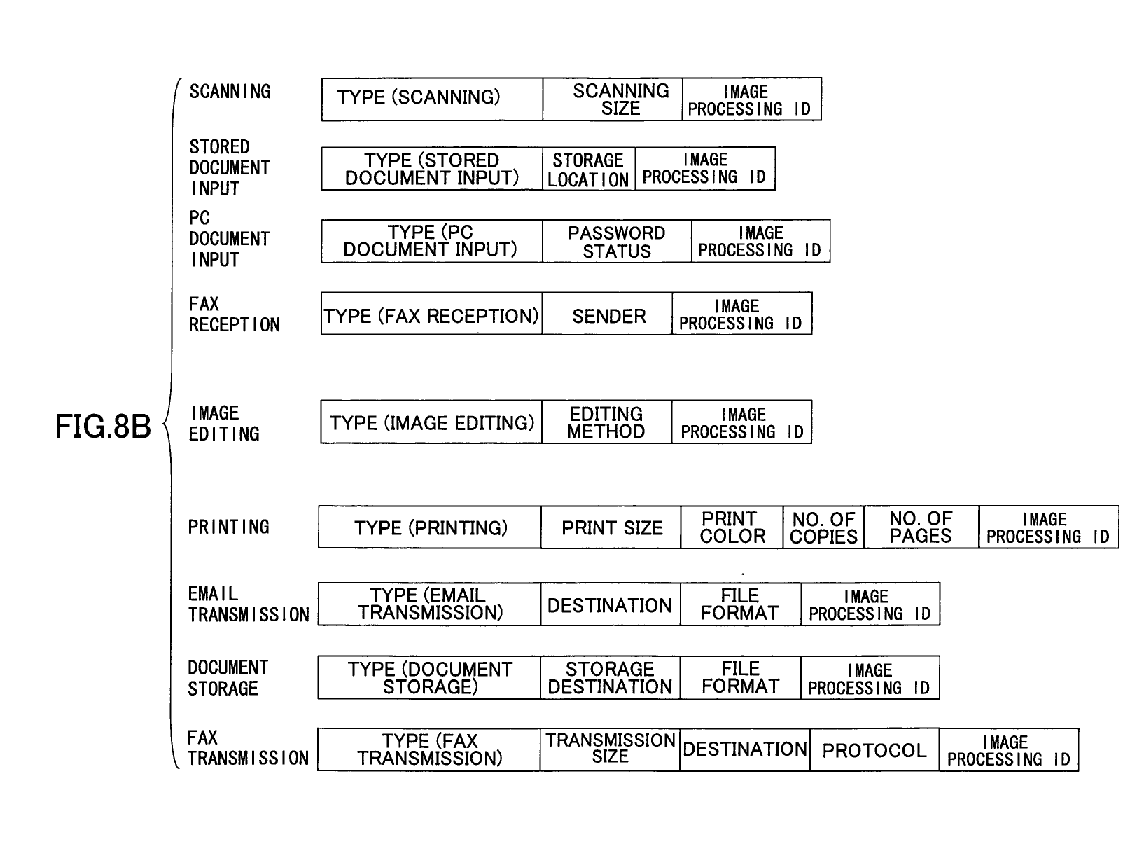

FIGS. 8A and 8B are drawings illustrating exemplary log formats. FIG. 8A shows an activity log format and FIG. 8B shows filter log formats. Log formats are contained in the corresponding activities and filters and are also stored in the log displaying unit 15 so that they can be referenced during a log displaying process.

As shown in FIG. 8A, an activity log includes a log type field indicating filters used in an activity, a date/time field indicating the date/time when the activity is executed, a user name field indicating a user who executed the activity, a result field indicating the result of executing the activity, and an image processing ID field containing an image processing ID identifying the activity log or an image processing job performed by the activity and used to link the activity log and the corresponding filter logs.

FIG. 8B shows formats of input filter logs, a processing filter log, and output filter logs. Input filter logs include a scanning log, a stored document input log, a PC document input log, and a fax reception log. A scanning log includes a filter type field, a scanning size field, and an image processing ID field. A stored document input log includes a filter type field, a storage location field, and an image processing ID field. A PC document input log includes a filter type field, a password status field, and an image processing ID field. A fax reception log includes a filter type field, a sender field, and an image processing ID field.

As a processing filter log, an image editing log is shown in FIG. 8B. An image editing log includes a filter type field, an editing method field, and an image processing ID field.

Output filter logs include a printing log, an email transmission log, a document storage log, and a fax transmission log. A printing log includes a filter type field, a print size field, a print color field, a number-of-copies field, a number-of-pages field, and an image processing ID field. An email transmission log includes a filter type field, a destination field, a file format field, and an image processing ID field. A document storage log includes a filter type field, a storage destination field, a file format field, and an image processing ID field. A fax transmission log includes a filter type field, a transmission size field, a destination field, a protocol field, and an image processing ID field.

Thus, an activity log and filter logs in the MFP 1 are recorded separately but can be linked by an image processing ID. With this configuration, for example, when the number of input filters is 4, the number of output filters is 4, the maximum number of input filters selectable (multiple input) is 4, and the maximum number of output filters selectable (multiple output) is 4, only nine log formats (or ten log formats including the image editing log) are necessary.

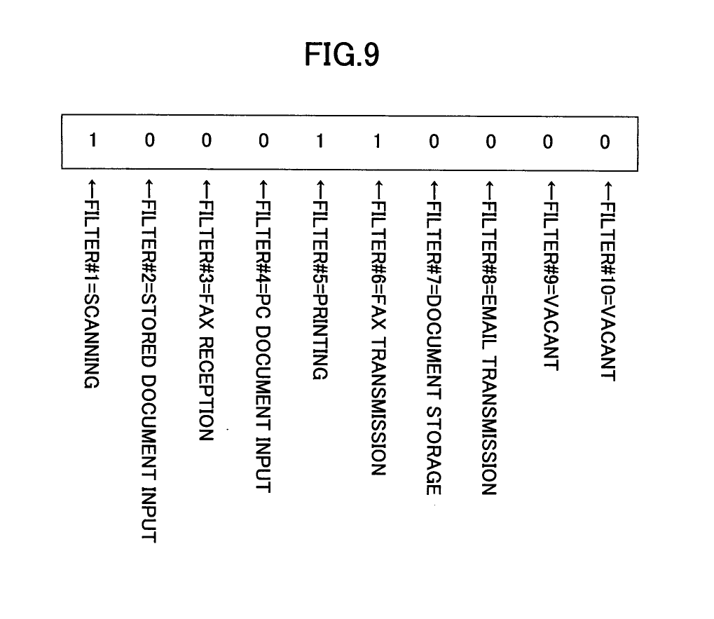

FIG. 9 is a drawing illustrating an exemplary format of the log type field in an activity log. The log type field contains information indicating filters used in the activity instead of information indicating the type of the activity such as “copy” and “fax transmission”. As shown in FIG. 9, the log type field contains ten bits used as flags assigned to filters #1 through #10. When a flag is 1, it indicates that the filter assigned to the flag is used in the activity. For example, in FIG. 9, “1000110000” indicates that the scanning filter, the printing filter, and the fax transmission filter are used in the activity to scan, print, and fax a document.

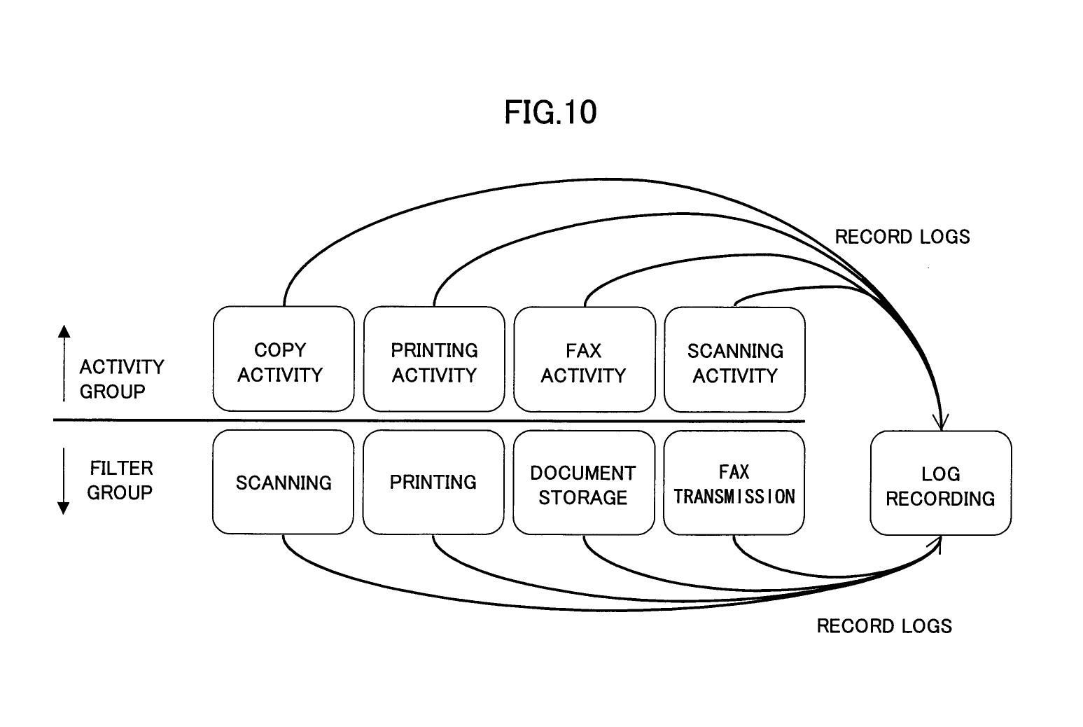

FIG. 10 is a drawing illustrating exemplary software architecture for recording logs according to an embodiment of the present invention. In this embodiment, each activity in the activity group sends an activity log to a log recording component and requests the log recording component to record the activity log, and each filter in the filter group sends a filter log to the log recording component and requests the log recording component to record the filter log. With this configuration, an activity does not have to know the log format of a newly-added filter to record a log of the filter.

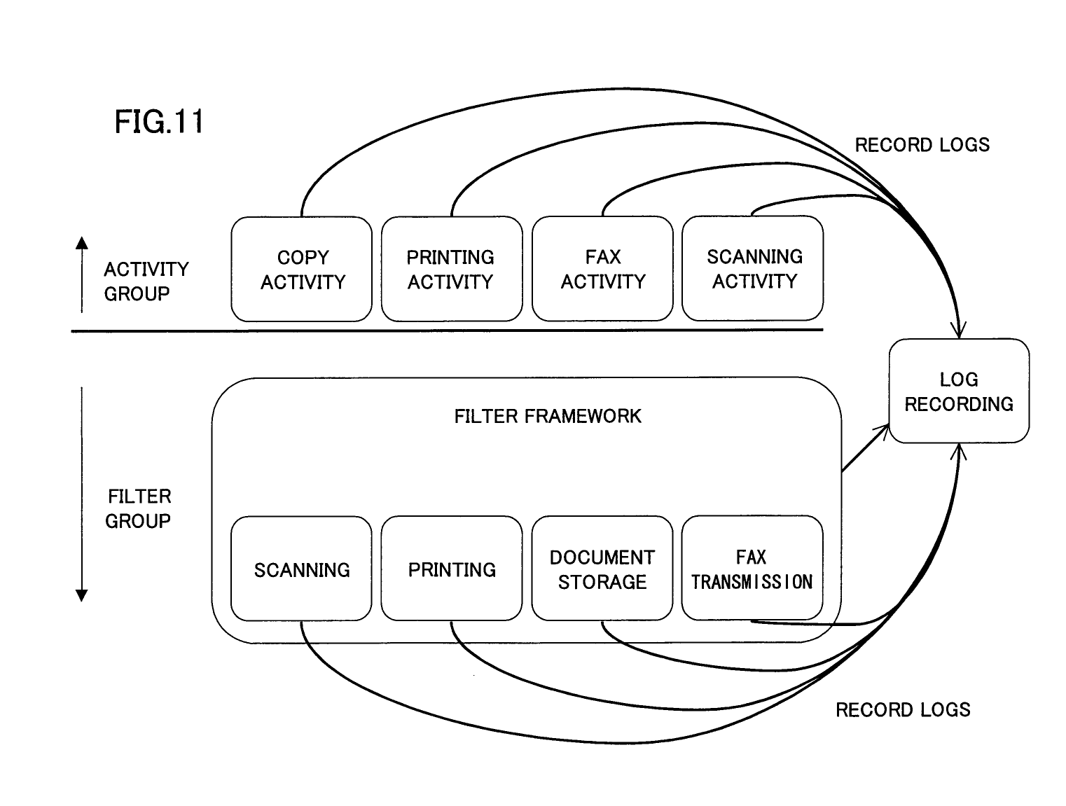

FIG. 11 is a drawing illustrating another exemplary software architecture for recording logs according to an embodiment of the present invention. This software architecture makes it possible to prevent a situation where a log of a newly-added filter is not recorded because of its design. The MFP 1 is configured to be able to download and install a filter created by a third party. One problem with this configuration is that whether a downloaded filter records a log depends on the design of the filter. However, if a downloaded filter is designed to perform a task concerning security and/or accounting, it is not preferable to allow execution of such a filter without recording a log.

To solve or reduce this problem, the software architecture shown in FIG. 11 includes a filter framework on which filters operate. Since filters operate on the filter framework, the filter framework is executed when a filter is executed. The filter framework records important logs concerning security and/or accounting for filters. Therefore, this software architecture prevents a filter from being executed without recording an important log concerning security and/or accounting.

### <Log Recording Settings>

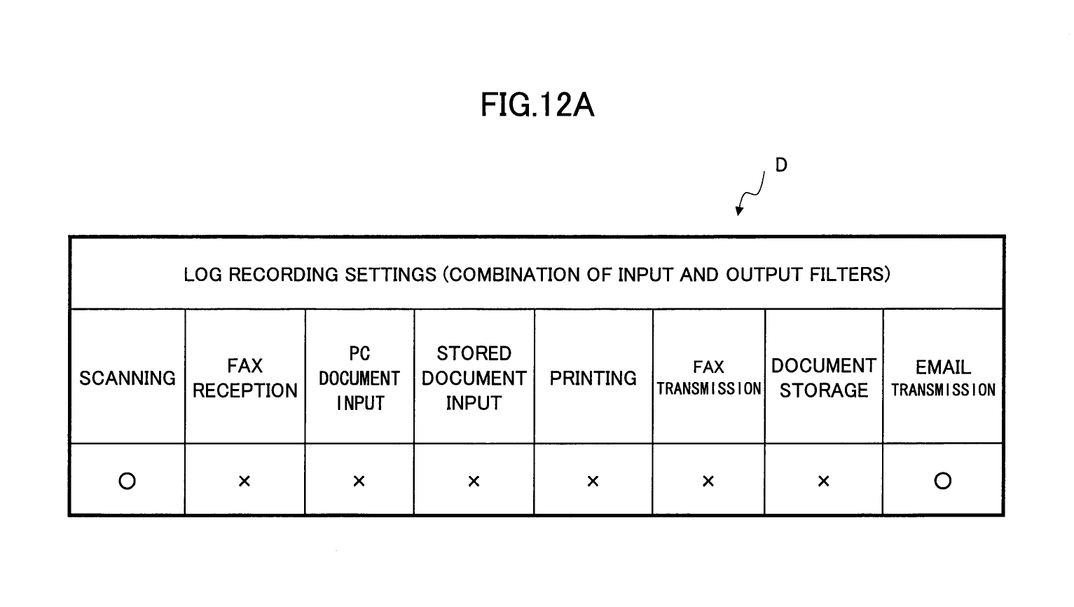

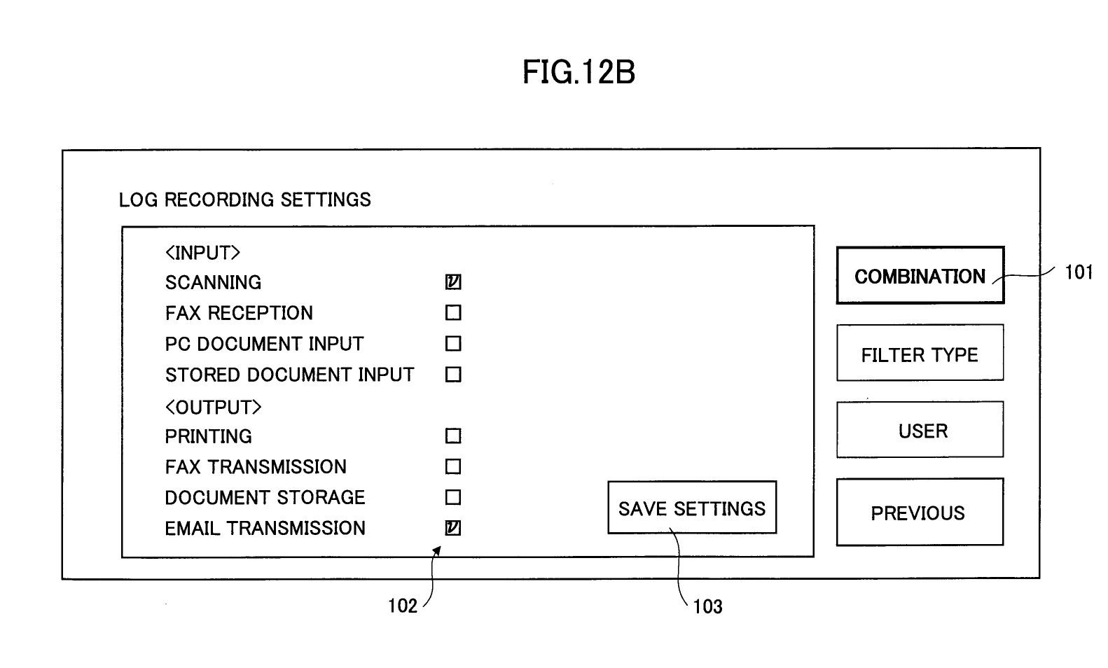

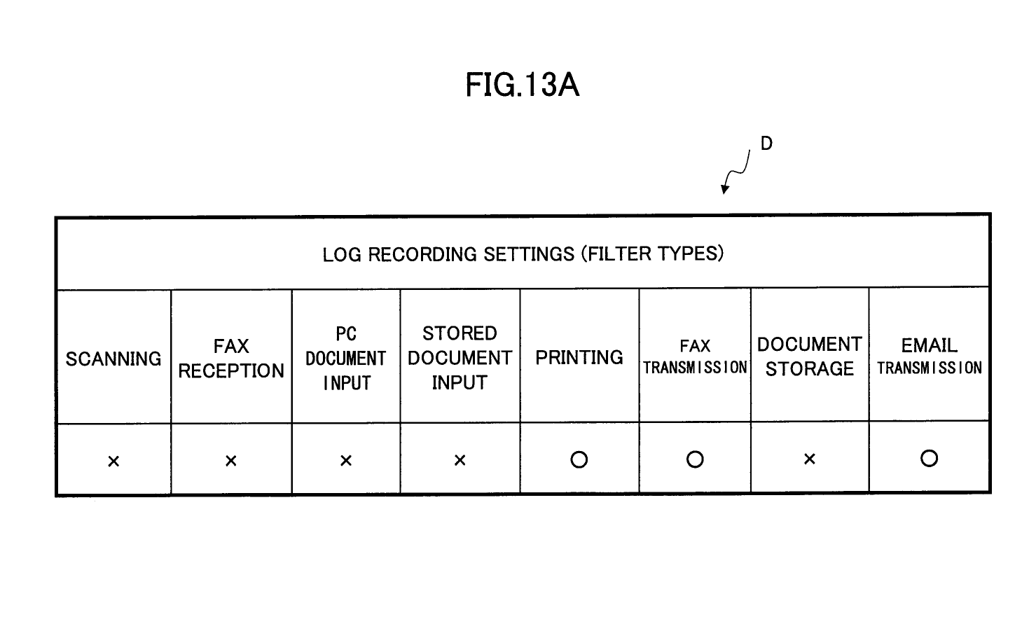

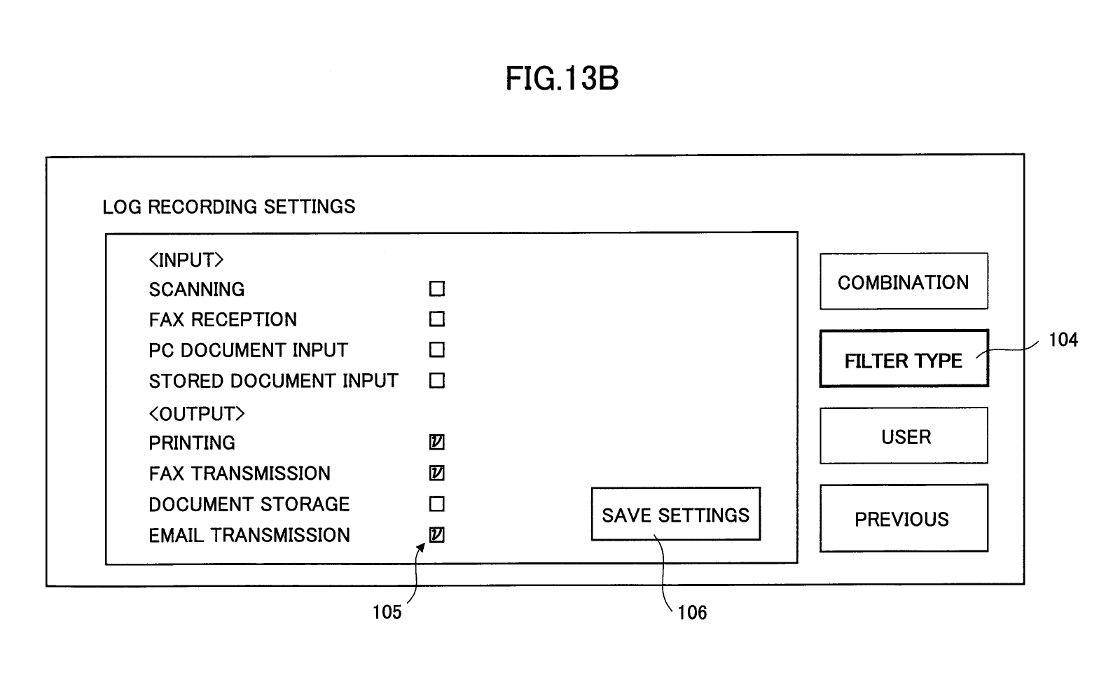

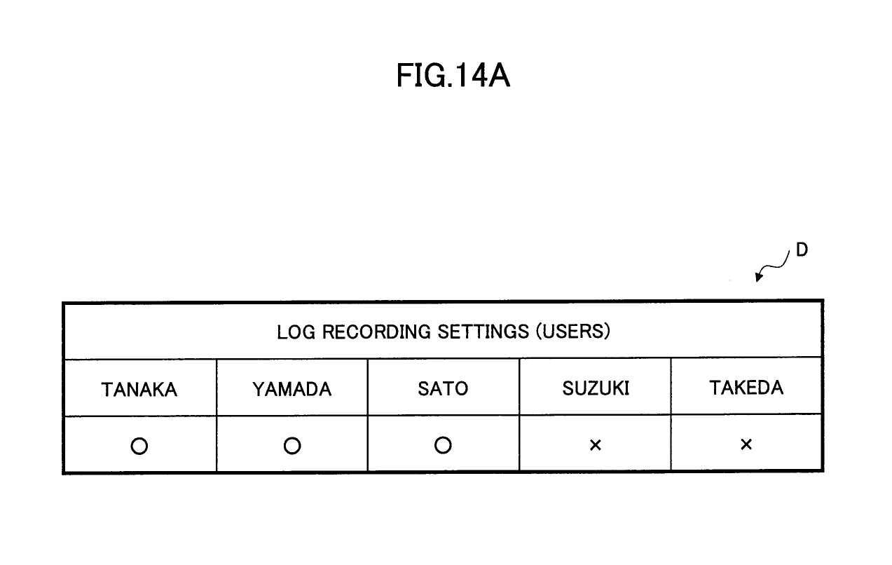

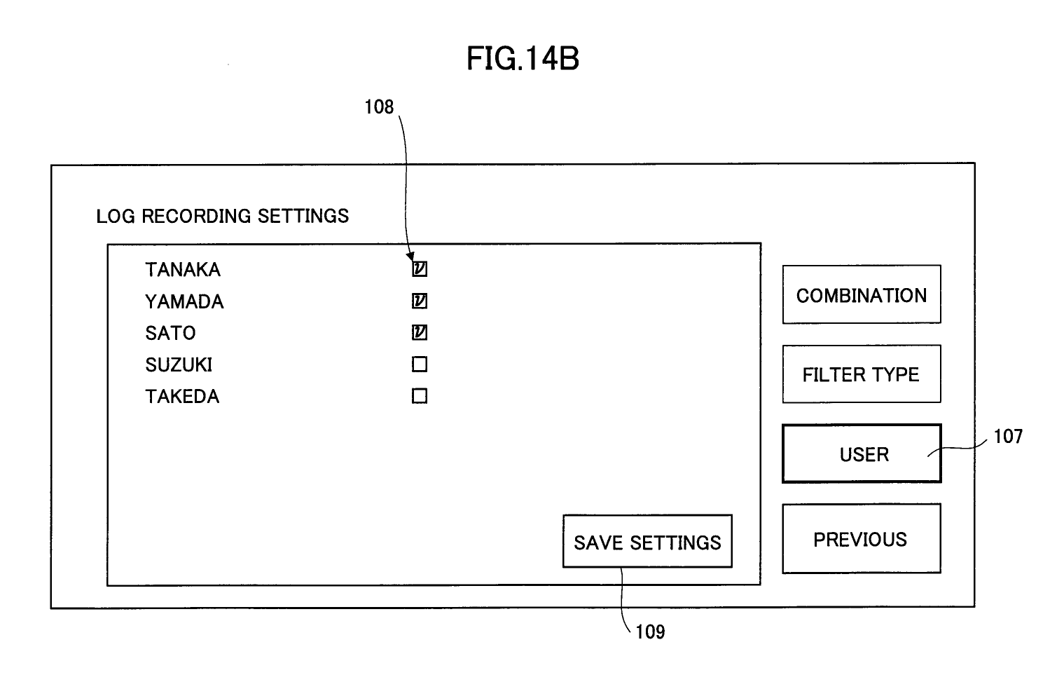

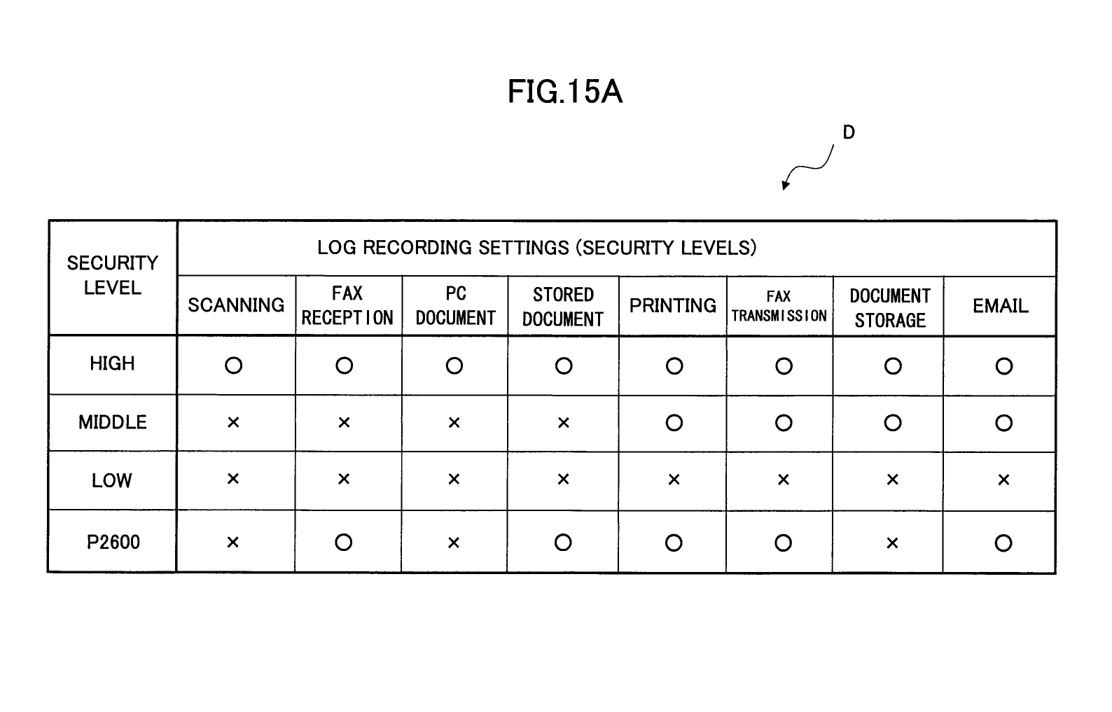

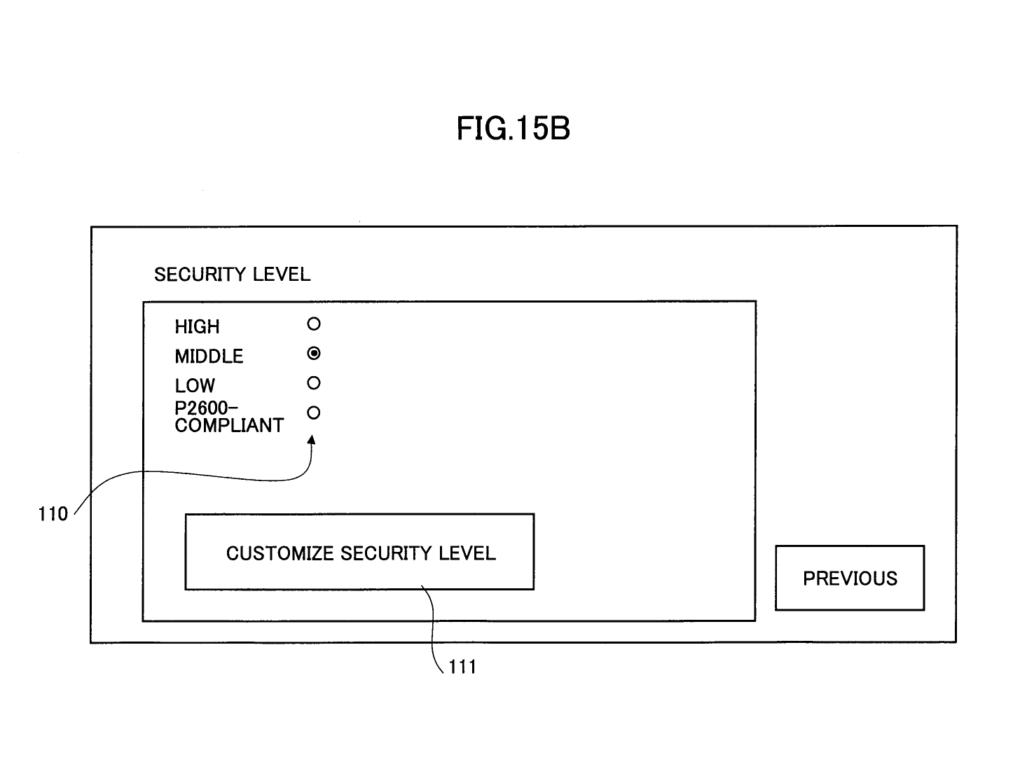

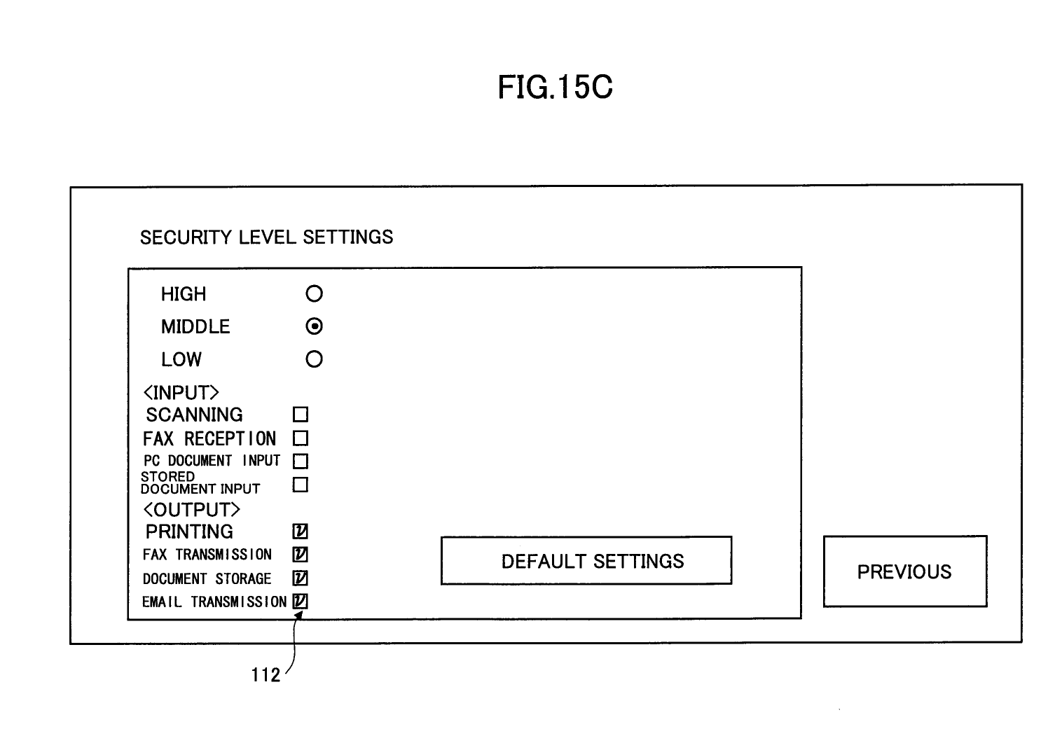

FIGS. 12A and 12B show exemplary log recording settings for specifying a combination of input and output filters which combination is used to determine whether to record filter logs, and an interface for making the log recording settings. FIGS. 13A and 13B show exemplary log recording settings for specifying filters whose logs are to be recorded, and an interface for making the log recording settings. FIGS. 14A and 14B show exemplary log recording settings for specifying, by user accounts, logs to be recorded, and an interface for making the log recording settings. FIGS. 15A through 15C show exemplary log recording settings for specifying, by security levels, logs to be recorded, and interfaces for making the log recording settings. The interfaces or screens for making log recording settings are, for example, provided by the UI unit 12.

FIG. 12A shows exemplary log recording settings D for specifying a combination of input and output filters which combination is used to determine whether to record filter logs. In this example, two of the scanning filter, the fax reception filter, the PC document input filter, the stored document input filter, the printing filter, the fax transmission filter, the document storage filter, and the email transmission filter are specified (indicated by “◯”). The log recording unit 17 records logs of filters if the combination of the filters is specified in the log recording settings D. As shown in FIG. 12B, when the user presses a “Combination” button 101, a setting screen for specifying a combination of input and output filters is displayed. On the setting screen, the user selects check boxes 102 corresponding to a desired combination of filters and then presses a “Save Settings” button 103 to save the settings.

FIG. 13A shows exemplary log recording settings D for specifying filters whose logs are to be recorded. In this example, three of the scanning filter, the fax reception filter, the PC document input filter, the stored document input filter, the printing filter, the fax transmission filter, the document storage filter, and the email transmission filter are specified (indicated by “◯”) and logs of the specified filters are to be recorded. As shown in FIG. 13B, when the user presses a “Filter Type” button 104, a setting screen for specifying filters is displayed. On the setting screen, the user selects check boxes 105 corresponding to desired filters and then presses a “Save Settings” button 106 to save the settings.

FIG. 14A shows exemplary log recording settings D for specifying, by user accounts, logs to be recorded.

In this example, three of users “Tanaka”, “Yamada”, “Sato”, “Suzuki”, and “Takeda” are specified (indicated by “◯”) and logs of activities and filters executed by the specified users are recorded. As shown in FIG. 14B, when the user presses a “User” button 107, a setting screen for specifying users is displayed. On the setting screen, the user selects check boxes 108 corresponding to desired users and then presses a “Save Settings” button 109 to save the settings.

FIG. 15A shows exemplary log recording settings D for specifying, by security levels, logs to be recorded. In this example, filters whose logs are to be recorded are specified (indicated by “◯”) for each of security levels “High”, “Middle”, “Low”, and “P2600 compliant”. “P2600” indicates a “Standard for Information Technology: Hardcopy System and Device Security” defined by Institute of Electrical and Electronic Engineers (IEEE).

FIG. 15B shows a setting screen for specifying a security level. The user can specify a security level by selecting one of radio buttons 110 on the setting screen. When the user presses a “Customize Security Level” button 111, a screen for selecting filters for each security level is displayed. Filters for the “P2600 compliant” security level are fixed and cannot be customized.

### <Log Recording Process>

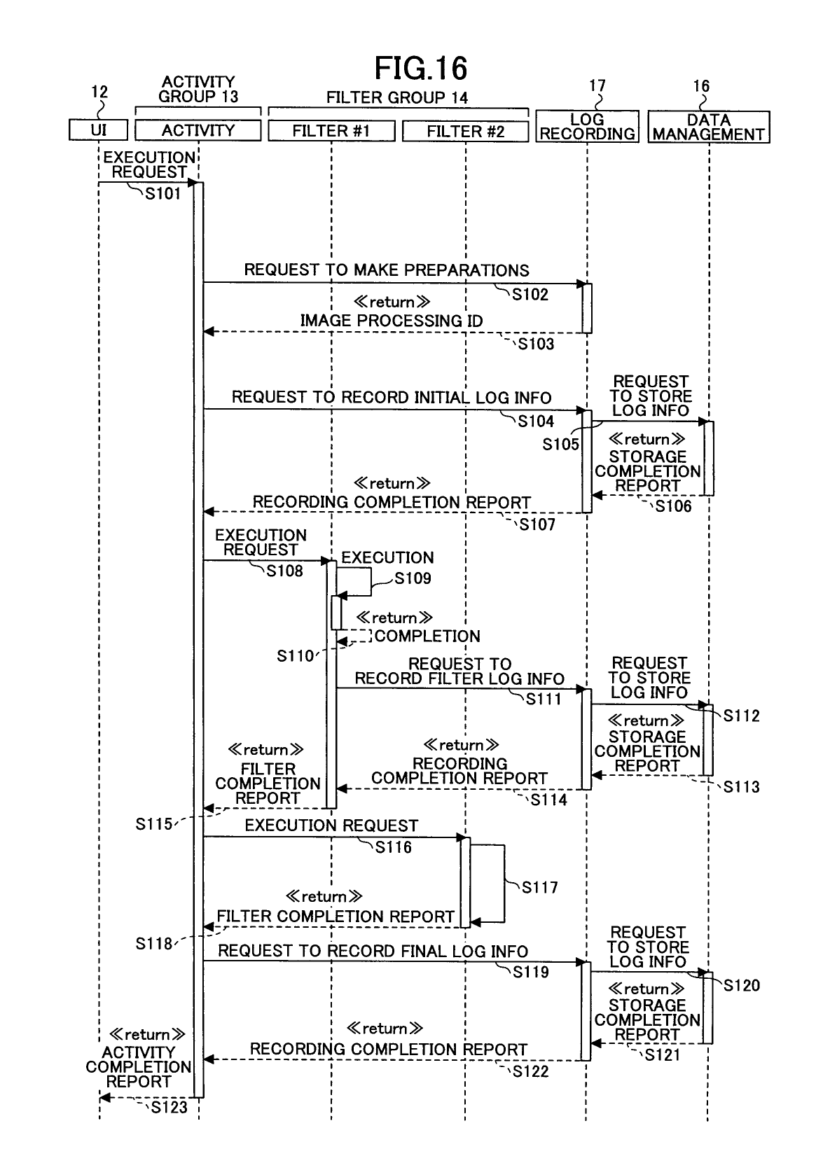

FIGS. 16 through 19 are sequence charts showing exemplary log recording processes. FIG. 16 shows an exemplary basic log recording process.

In FIG. 16, it is assumed that an activity of the activity group 13 to be executed in the exemplary process uses filters #1 and #2 of the filter group 14.

When a user requests execution of an activity from the UI unit 12 of the MFP 1 (step S101), the activity requests the log recording unit 17 to make preparations for log recording (step S102). When the preparations are completed, the log recording unit 17 returns an image processing ID to the activity (step S103).

Next, the activity sends initial log information (e.g. log type and date/time) to be recorded at the start of the activity together with the image processing ID to the log recording unit 17 and requests the log recording unit 17 to record the initial log information (step S104). The log recording unit 17 requests the data management unit 16 to store the initial log information (step S105). After storing the initial log information, the data management unit 16 sends a storage completion report to the log recording unit 17 (step S106). Then, the log recording unit 17 returns a recording completion report to the activity (step S107). Alternatively, the MFP 1 may be configured to record the initial log information at the end of the activity together with other information. In such a case, steps S104 through S107 may be omitted.

After step S107, the activity sends the image processing ID to the filter #1 of the filter group 14 and requests the filter #1 to perform its task (sends an execution request to the filter #1) (step S108). When requested, the filter #1 performs its task (step S109). After confirming the completion of the task (step S110), the filter #1 sends filter log information to the log recording unit 17 and requests the log recording unit 17 to record the filter log information (step S111). The log recording unit 17 requests the data management unit 16 to store the filter log information (step S112). After storing the filter log information, the data management unit 16 sends a storage completion report to the log recording unit 17 (step S113). The log recording unit 17 returns a recording completion report to the filter #1 (step S114). Then, the filter #1 sends a filter completion report to the activity (step S115).

The steps to be performed for the filter #2 are substantially the same as those (steps S108 through S115) for the filter #1. Therefore, in FIG. 16, the steps to be performed for the filter #2 are simplified and represented by steps S116 through S118.

After step S118, the activity sends final log information (e.g. the result) to be recorded at the end of the activity to the log recording unit 17 and requests the log recording unit 17 to record the final log information (step S119). The log recording unit 17 requests the data management unit 16 to store the final log information (step S120). After storing the final log information, the data management unit 16 sends a storage completion report to the log recording unit 17 (step S121). The log recording unit 17 returns a recording completion report to the activity (step S122).

Then, the activity returns an activity completion report to the UI unit 12 (step S123) and terminates the process.

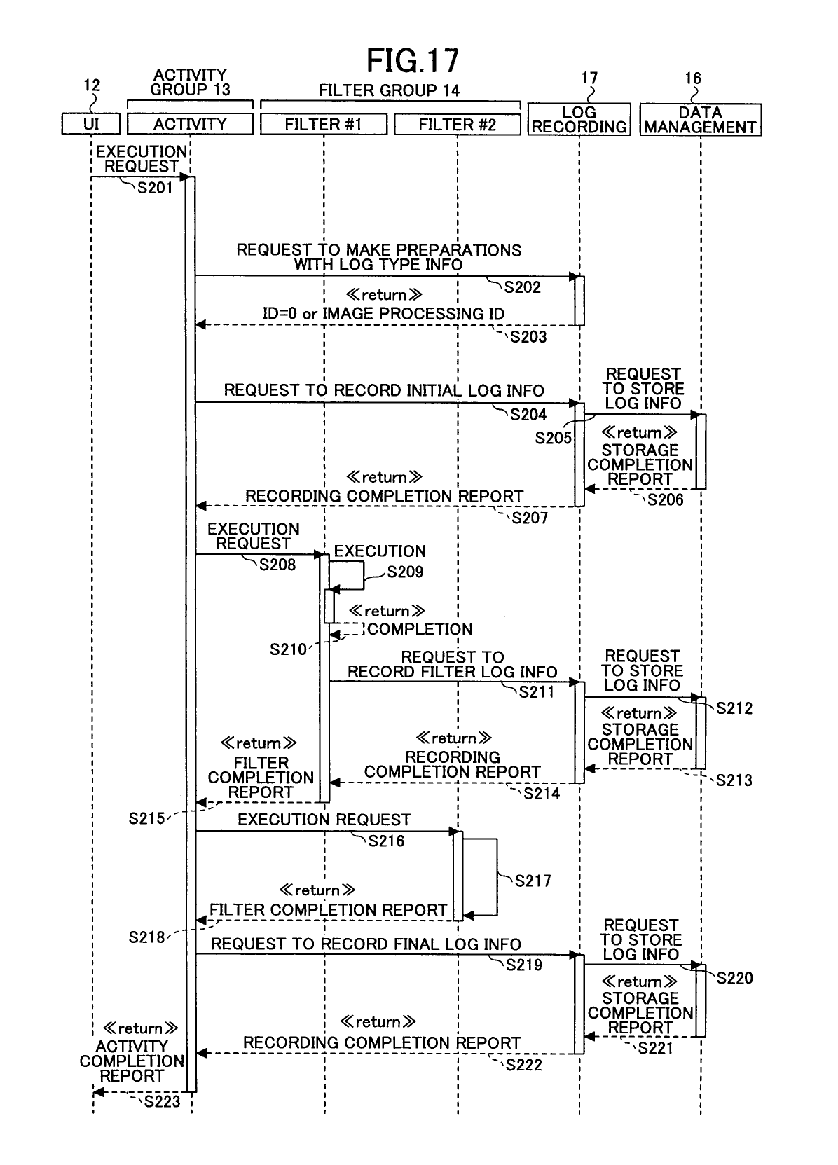

FIG. 17 shows an exemplary log recording process where logs of input and output filters are recorded if the combination of the input and output filters is specified in the log recording settings D. In FIG. 17, it is assumed that an activity of the activity group 13 to be executed in the exemplary process uses filters #1 and #2 of the filter group 14.

When a user requests execution of an activity from the UI unit 12 of the MFP 1 (step S201), the activity sends log type information (as shown in FIG. 9) to the log recording unit 17 and requests the log recording unit 17 to make preparations for log recording (step S202). If the combination of filters indicated by the log type information is not specified in the log recording settings D, the log recording unit 17 returns “ID=0” to the activity. If the combination is specified in the log recording settings D, the log recording unit 17 performs the preparations and returns an image processing ID to the activity (step S203).

If an image processing ID is returned from the log recording unit 17, the activity sends initial log information (e.g. log type and date/time) to be recorded at the start of the activity together with the image processing ID to the log recording unit 17 and requests the log recording unit 17 to record the initial log information (step S204). The log recording unit 17 requests the data management unit 16 to store the initial log information (step S205). After storing the initial log information, the data management unit 16 sends a storage completion report to the log recording unit 17 (step S206). Then, the log recording unit 17 returns a recording completion report to the activity (step S207). Alternatively, the MFP 1 may be configured to record the initial log information at the end of the activity together with other information. In such a case, steps S204 through S207 may be omitted.

After step S207, the activity sends the image processing ID to the filter #1 of the filter group 14 and requests the filter #1 to perform its task (sends an execution request to the filter #1) (step S208). When requested, the filter #1 performs its task (step S209). After confirming the completion of the task (step S210), the filter #1 sends filter log information to the log recording unit 17 and requests the log recording unit 17 to record the filter log information (step S211). The log recording unit 17 requests the data management unit 16 to store the filter log information (step S212). After storing the filter log information, the data management unit 16 sends a storage completion report to the log recording unit 17 (step S213). The log recording unit 17 returns a recording completion report to the filter #1 (step S214). Then, the filter #1 sends a filter completion report to the activity (step S215).

The steps to be performed for the filter #2 are substantially the same as those (steps S208 through S215) for the filter #1. Therefore, in FIG. 17, the steps to be performed for the filter #2 are simplified and represented by steps S216 through S218.

After step S218, the activity sends final log information (e.g. the result) to be recorded at the end of the activity to the log recording unit 17 and requests the log recording unit 17 to record the final log information (step S219). The log recording unit 17 requests the data management unit 16 to store the final log information (step S220). After storing the final log information, the data management unit 16 sends a storage completion report to the log recording unit 17 (step S221). The log recording unit 17 returns a recording completion report to the activity (step S222).

Then, the activity returns an activity completion report to the UI unit 12 (step S223) and terminates the process.

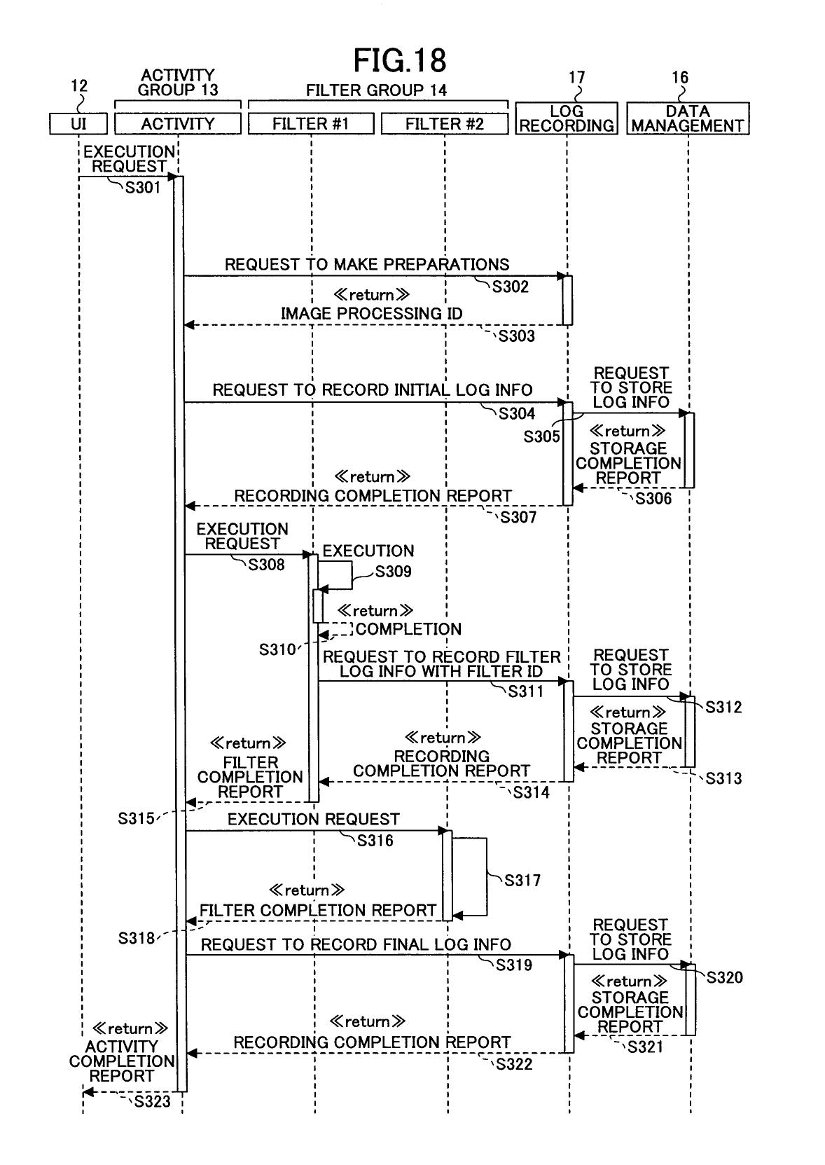

FIG. 18 shows an exemplary log recording process where logs of specified filters are recorded. In FIG. 18, it is assumed that an activity of the activity group 13 to be executed in the exemplary process uses filters #1 and #2 of the filter group 14.

When a user requests execution of an activity from the UI unit 12 of the MFP 1 (step S301), the activity requests the log recording unit 17 to make preparations for log recording (step S302). When the preparations are completed, the log recording unit 17 returns an image processing ID to the activity (step S303).

Next, the activity sends initial log information (e.g. log type and date/time) to be recorded at the start of the activity together with the image processing ID to the log recording unit 17 and requests the log recording unit 17 to record the initial log information (step S304). The log recording unit 17 requests the data management unit 16 to store the initial log information (step S305). After storing the initial log information, the data management unit 16 sends a storage completion report to the log recording unit 17 (step S306). Then, the log recording unit 17 returns a recording completion report to the activity (step S307). Alternatively, the MFP 1 may be configured to record the initial log information at the end of the activity together with other information. In such a case, steps S304 through S307 may be omitted.

After step S307, the activity sends the image processing ID to the filter #1 of the filter group 14 and requests the filter #1 to perform its task (sends an execution request to the filter #1) (step S308). When requested, the filter #1 performs its task (step S309). After confirming the completion of the task (step S310), the filter #1 sends filter log information together with a filter ID to the log recording unit 17 and requests the log recording unit 17 to record the filter log information (step S311). If the corresponding filter is specified in the log recording settings D, the log recording unit 17 requests the data management unit 16 to store the filter log information (step S312). After storing the filter log information, the data management unit 16 sends a storage completion report to the log recording unit 17 (step S313). The log recording unit 17 returns a recording completion report to the filter #1 (step S314). Then, the filter #1 sends a filter completion report to the activity (step S315).

The steps to be performed for the filter #2 are substantially the same as those (steps S308 through S315) for the filter #1. Therefore, in FIG. 18, the steps to be performed for the filter #2 are simplified and represented by steps S316 through S318.

After step S318, the activity sends final log information (e.g. the result) to be recorded at the end of the activity to the log recording unit 17 and requests the log recording unit 17 to record the final log information (step S319). The log recording unit 17 requests the data management unit 16 to store the final log information (step S320). After storing the final log information, the data management unit 16 sends a storage completion report to the log recording unit 17 (step S321). The log recording unit 17 returns a recording completion report to the activity (step S322).

Then, the activity returns an activity completion report to the UI unit 12 (step S323) and terminates the process.

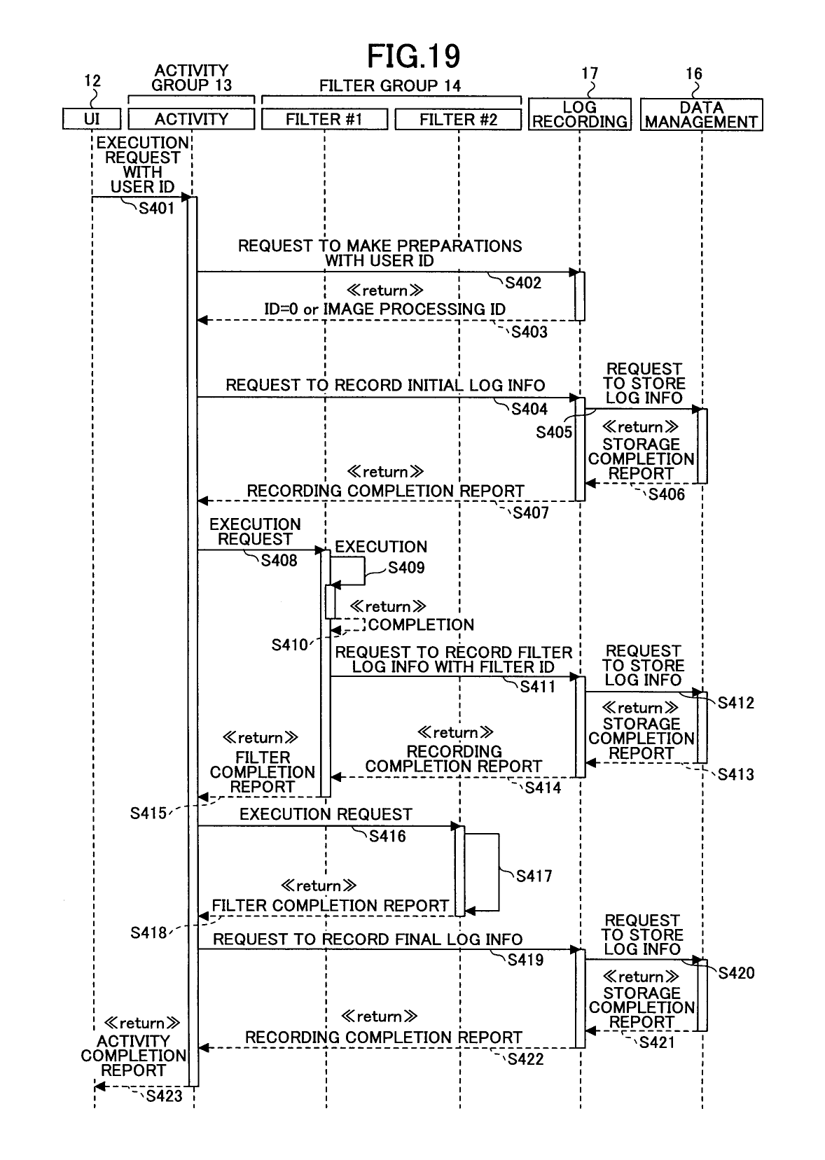

FIG. 19 shows an exemplary log recording process where logs are recorded when an activity is executed by a specified user. In FIG. 19, it is assumed that an activity of the activity group 13 to be executed in the exemplary process uses filters #1 and #2 of the filter group 14.

When a user sends a request to execute an activity together with a user ID from the UI unit 12 of the MFP 1 (step S401), the activity sends the user ID to the log recording unit 17 and requests the log recording unit 17 to make preparations for log recording (step S402). If the user indicated by the user ID is not specified in the log recording settings D, the log recording unit 17 returns “ID=0” to the activity. If the user is specified in the log recording settings D, the log recording unit 17 performs the preparations and returns an image processing ID to the activity (step S403).

If an image processing ID is returned from the log recording unit 17, the activity sends initial log information (e.g. log type and date/time) to be recorded at the start of the activity together with the image processing ID to the log recording unit 17 and requests the log recording unit 17 to record the initial log information (step S404). The log recording unit 17 requests the data management unit 16 to store the initial log information (step S405). After storing the initial log information, the data management unit 16 sends a storage completion report to the log recording unit 17 (step S406). Then, the log recording unit 17 returns a recording completion report to the activity (step S407). Alternatively, the MFP 1 may be configured to record the initial log information at the end of the activity together with other information. In such a case, steps S404 through S407 may be omitted.

After step S407, the activity sends the image processing ID to the filter #1 of the filter group 14 and requests the filter #1 to perform its task (sends an execution request to the filter #1) (step S408). When requested, the filter #1 performs its task (step S409). After confirming the completion of the task (step S410), the filter #1 sends filter log information to the log recording unit 17 and requests the log recording unit 17 to record the filter log information (step S411). The log recording unit 17 requests the data management unit 16 to store the filter log information (step S412). After storing the filter log information, the data management unit 16 sends a storage completion report to the log recording unit 17 (step S413). The log recording unit 17 returns a recording completion report to the filter #1 (step S414). Then, the filter #1 sends a filter completion report to the activity (step S415).

The steps to be performed for the filter #2 are substantially the same as those (steps S408 through S415) for the filter #1. Therefore, in FIG. 19, the steps to be performed for the filter #2 are simplified and represented by steps S416 through S418.

After step S418, the activity sends final log information (e.g. the result) to be recorded at the end of the activity to the log recording unit 17 and requests the log recording unit 17 to record the final log information (step S419). The log recording unit 17 requests the data management unit 16 to store the final log information (step S420). After storing the final log information, the data management unit 16 sends a storage completion report to the log recording unit 17 (step S421). The log recording unit 17 returns a recording completion report to the activity (step S422).

Then, the activity returns an activity completion report to the UI unit 12 (step S423) and terminates the process.

### <Log Displaying Process>

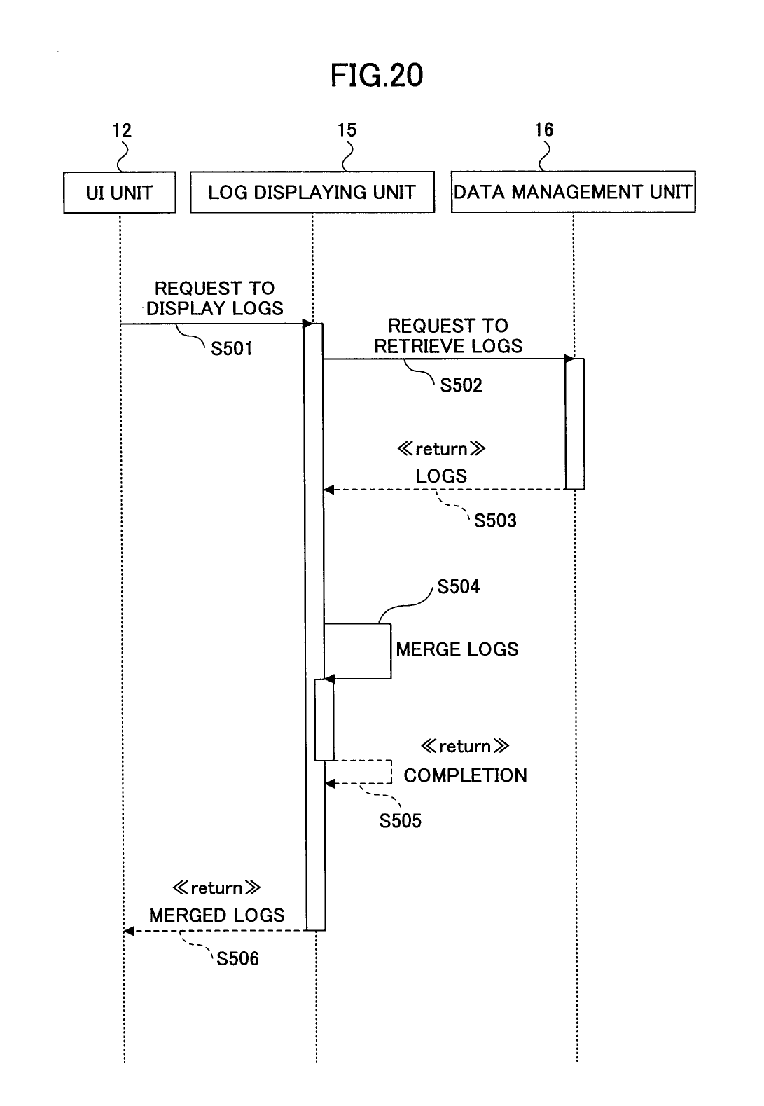

FIG. 20 is a sequence chart showing an exemplary log displaying process.

In FIG. 20, a user sends a request to display logs to the log displaying unit 15 from the UI unit 12 of the MFP 1 (step S501). The log displaying unit 15 requests the data management unit 16 to retrieve activity and filter logs (step S502). The data management unit 16 retrieves the activity and filter logs and sends them to the log displaying unit 15 (step S503).

Then, the log displaying unit 15 merges the activity logs and the filter logs and links them based on image processing IDs (step S504). After merging and linking the logs (step S505), the log displaying unit 15 sends the merged logs to the UI unit 12 (step S506).

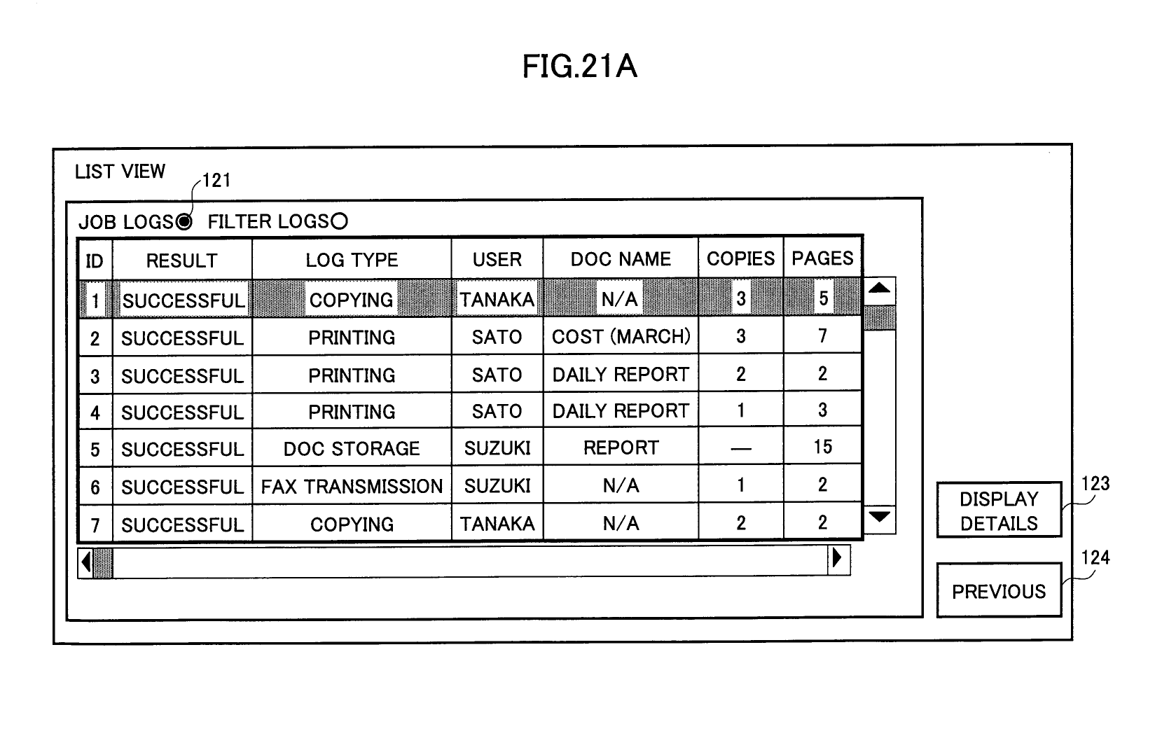

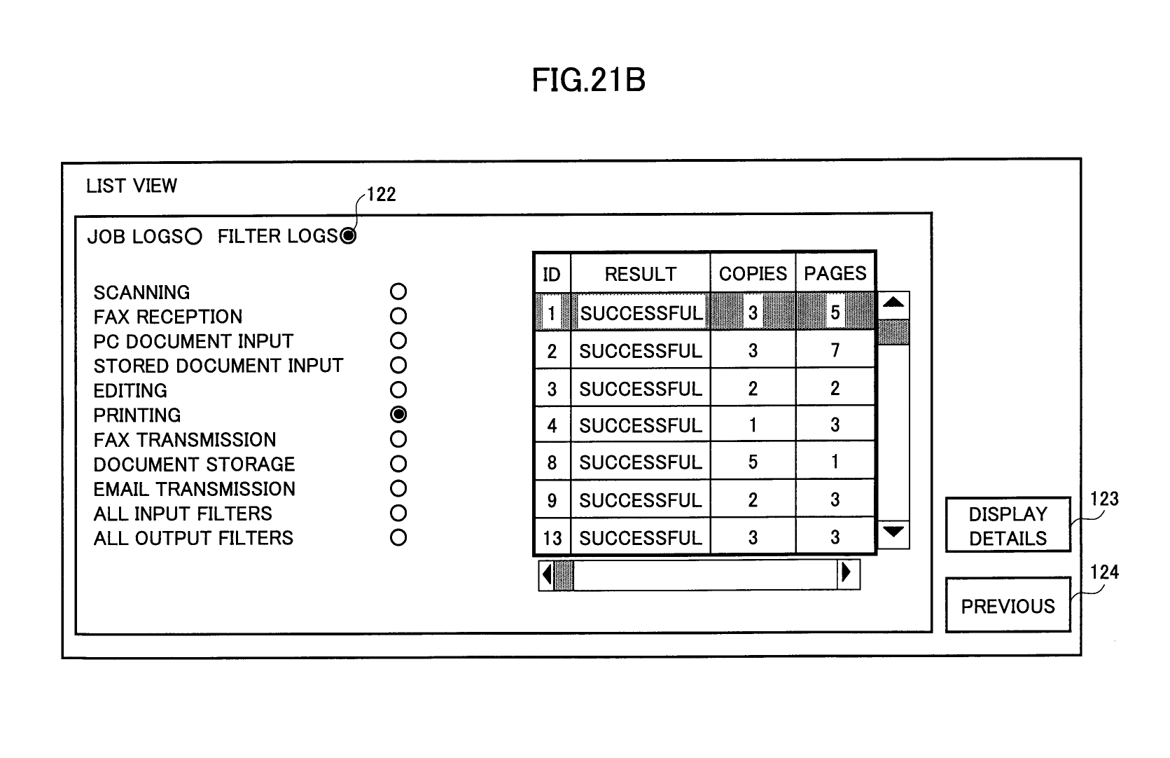

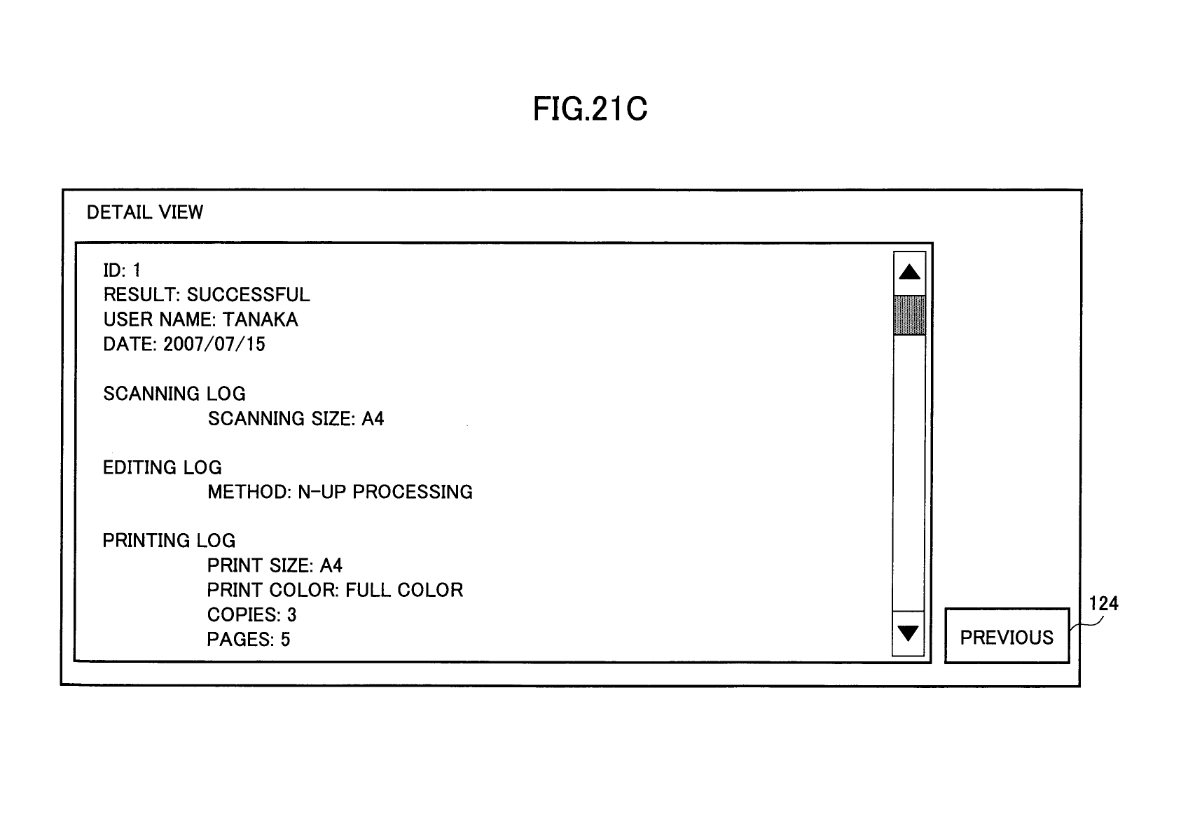

FIG. 21A shows an image processing log screen for displaying a list of activity logs or image processing logs of image processing jobs performed by activities. FIG. 21B shows a filter log screen displaying a list of filter logs. FIG. 21C shows a detail screen displaying details of a log. The user can switch between the image processing log screen and the filter log screen by selecting a “Job Logs” radio button 121 or a “Filter Logs” radio button 122. The image processing log screen enables a user to view multiple activity logs or summaries of multiple image processing logs at once. As shown in the example of FIG. 21A, an image processing log may include information (such as document names and the numbers of copies) obtained from filter logs together with information obtained from an activity log for user convenience.

Also, the user can select an image processing log or a filter log on the image processing log screen or the filter log screen (a selected log is highlighted) and display the details of the selected log on the detail screen shown in FIG. 21C by pressing a “Display Details” button 123. A “Previous” button 124 provided on each of the screens allows the user to return to a previous screen.

The user can view logs not only on the display unit of the UI unit 12 of the MFP 1 but also on a user terminal such as a PC connected to the MFP 1 via a network. For example, when the user sends a request to display logs from a PC, the network I/F 11 receives the request, sends the request to the log displaying unit 15, and returns screens for displaying the logs to the PC.

The MFP 1 can also output logs in various formats such as the CSV format and the Excel format, for example, to a USB flash memory connected to the MFP 1 or to a PC connected to the MFP 1 via a network.

### Other Embodiments

In the embodiments described above, activity logs and filter logs are stored separately and are merged based on image processing IDs when displayed. One problem with this method is that it takes much time to merge a large number of logs stored, for example, in a hard disk drive, and this slows down the process of displaying logs. In this embodiment, logs of filters in an activity are merged when they are stored to speed up the process of displaying logs.

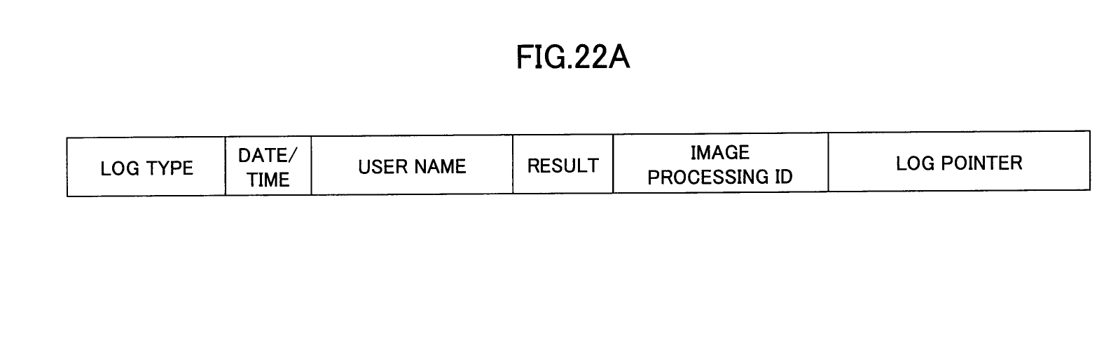

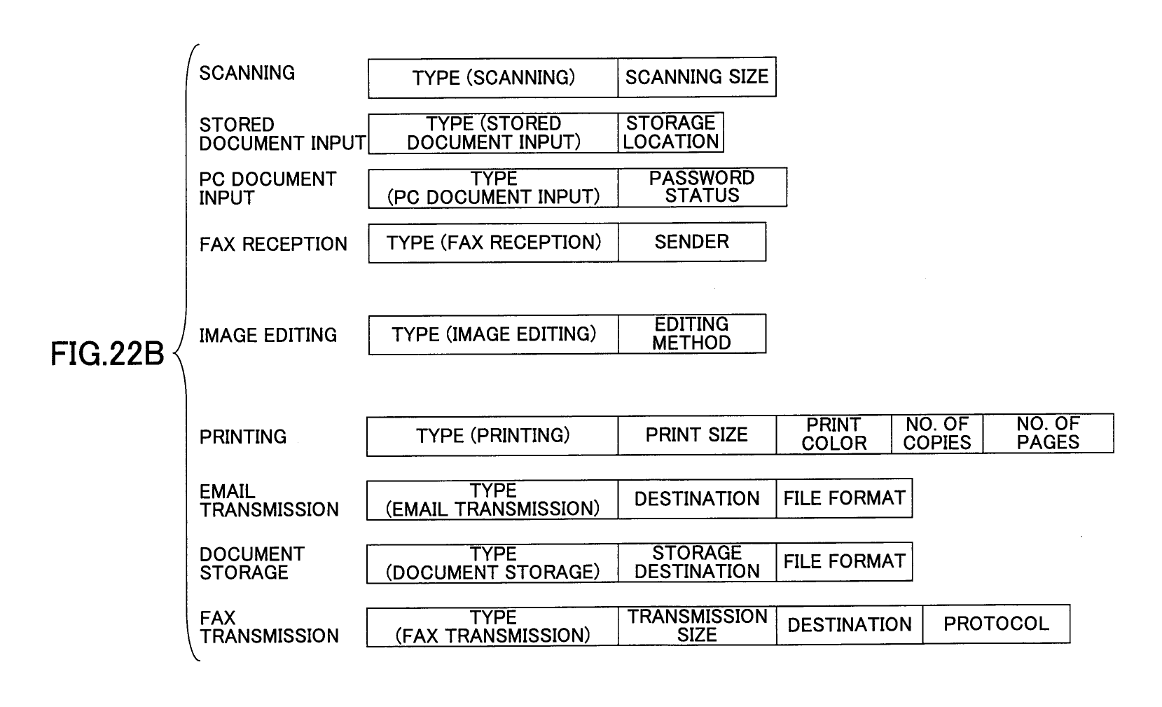

FIGS. 22A and 22B are drawings illustrating other exemplary log formats. FIG. 22A shows a format of an activity log(that forms a basic part of an image processing log and may also be called a common log) and FIG. 22B shows formats of filter logs.

As shown in FIG. 22A, an activity log includes a log type field containing information indicating that the log is a base part of an image processing log, a date/time field indicating the date/time when an activity is executed, a user name field indicating a user who executed the activity, a result field indicating the result of executing the activity, an image processing ID field containing an image processing ID identifying the image processing job performed by the activity, and a log pointer field containing pointers indicating locations of logs of filters used in the activity. In the above embodiments, a log type field is designed to contain flags indicating filters used in an activity. Therefore, in the above embodiment, the number of filters whose logs are recorded is limited to the number of flags in the log type field. On the other hand, with the log formats of this embodiment, it is possible to record any number of filter logs.

As described above, the exemplary activity log format shown in FIG. 22A includes fields (e.g. date/time, user name, result, and image processing ID) related to execution of an activity. Alternatively, those fields may be included in filter logs and removed from the activity log.

FIG. 22B shows formats of input filter logs, a processing filter log, and output filter logs. Input filter logs include a scanning log, a stored document input log, a PC document input log, and a fax reception log. A scanning log includes a filter type field and a scanning size field. A stored document input log includes a filter type field and a storage location field. A PC document input log includes a filter type field and a password status field. A fax reception log includes a filter type field and a sender field.

As a processing filter log, an image editing log is shown in FIG. 22B. An image editing log includes a filter type field and an editing method field.

Output filter logs include a printing log, an email transmission log, a document storage log, and a fax transmission log. A printing log includes a filter type field, a print size field, a print color field, a number-of-copies field, and a number-of-pages field. An email transmission log includes a filter type field, a destination field, and a file format field. A document storage log includes a filter type field, a storage destination field, and a file format field. A fax transmission log includes a filter type field, a transmission size field, a destination field, and a protocol field.

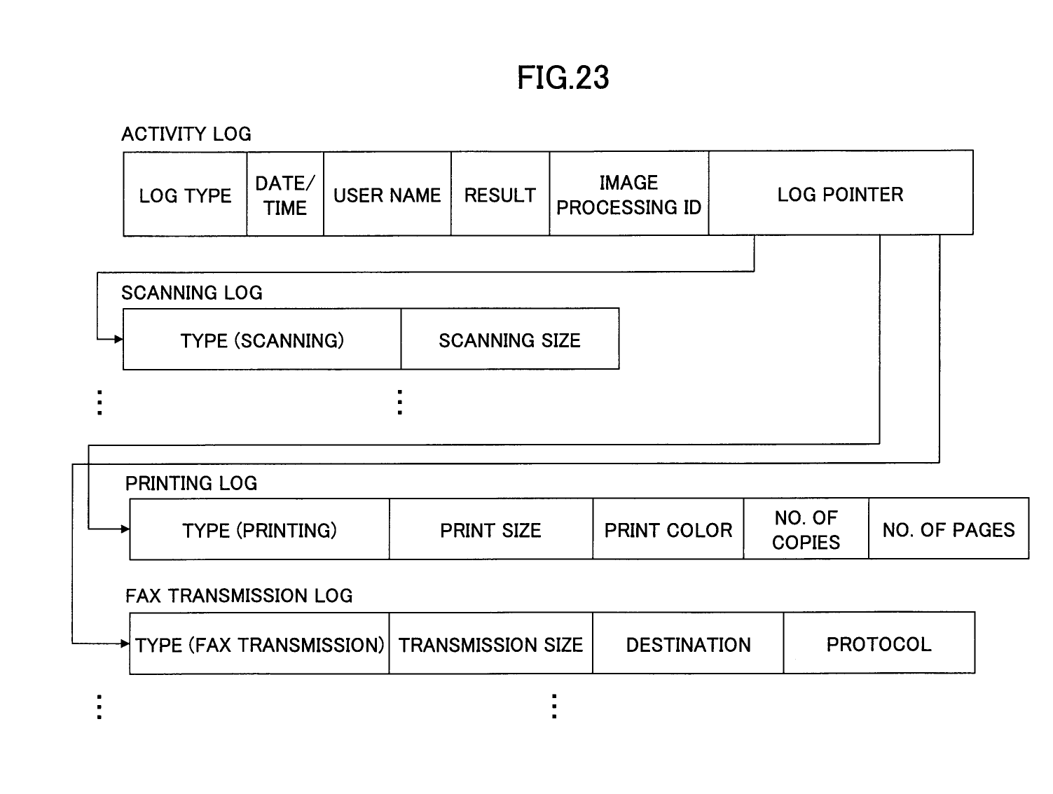

FIG. 23 shows an example of linked logs. In FIG. 23, filter logs including a scanning log, a printing log, and a fax transmission log are linked to an activity log by pointers in the log pointer field. With this method, filter logs can be retrieved directly by following the pointers in an activity log. Compared with a method using image processing IDs to merge logs, using pointers can greatly speed up the process of displaying logs.

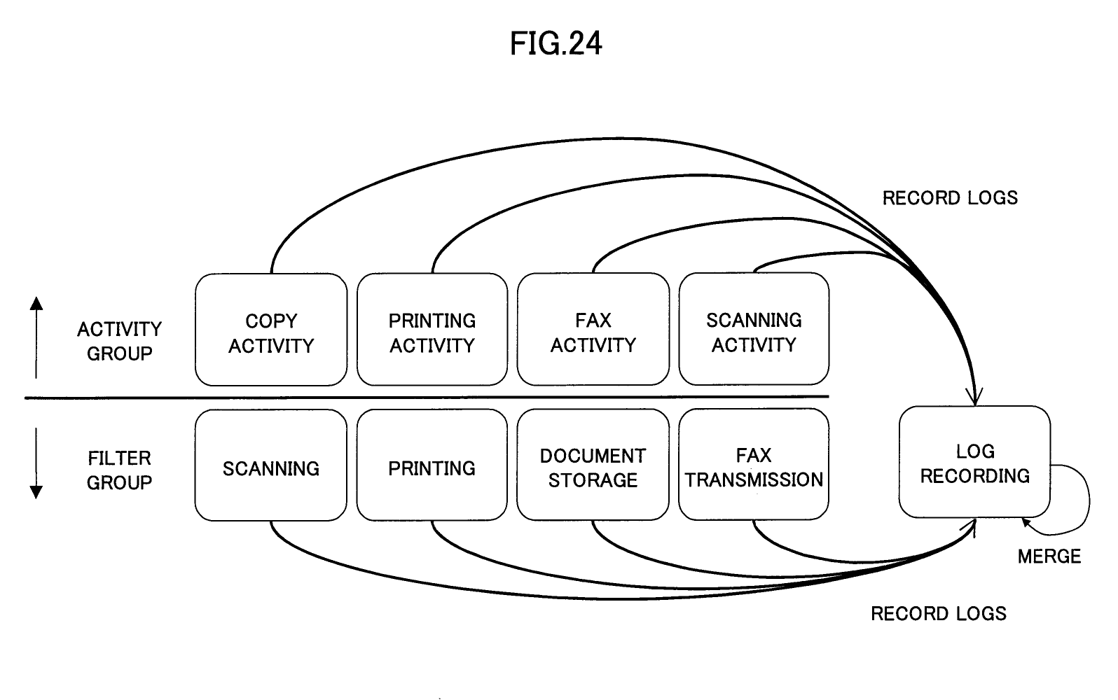

FIG. 24 is a drawing illustrating still another exemplary software architecture for recording logs according to an embodiment of the present invention. In this embodiment, each activity in the activity group sends an activity log to a log recording component and requests the log recording component to record the activity log, and each filter in the filter group sends a filter log to the log recording component and requests the log recording component to record the filter log. In this embodiment, the log recording component merges received logs while recording the logs.

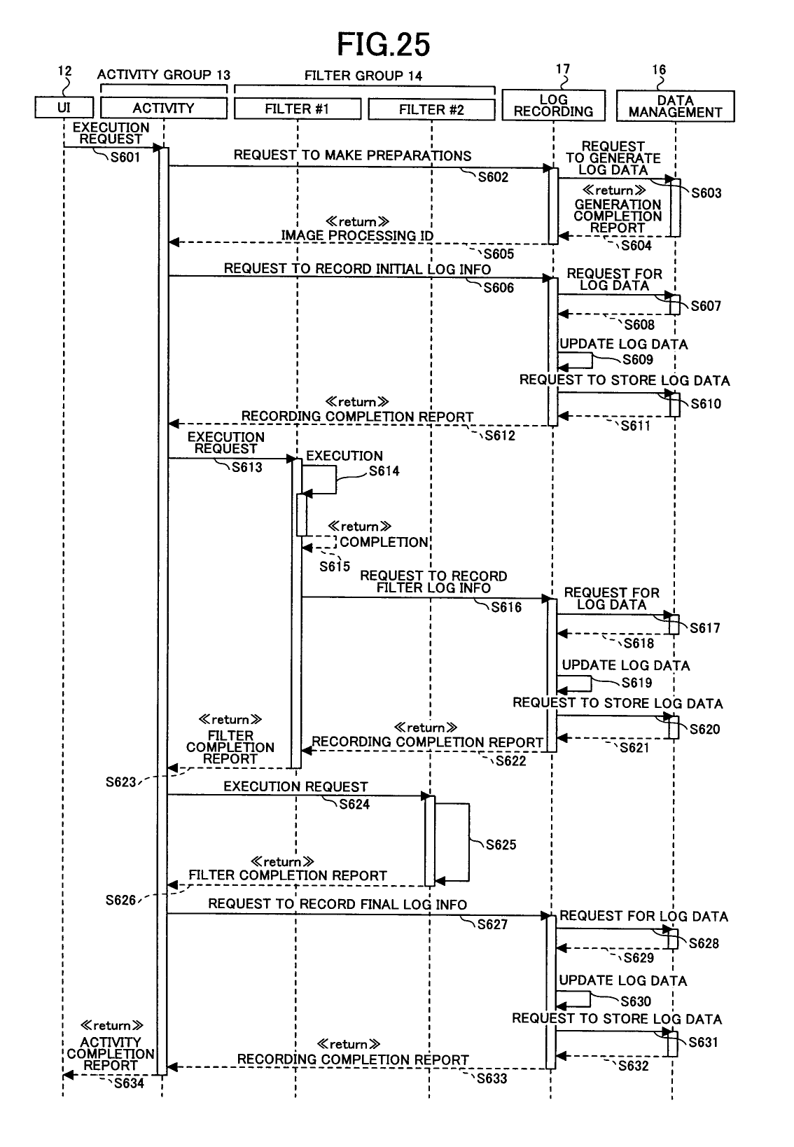

FIG. 25 is a sequence chart showing still another exemplary log recording process.

In FIG. 25, it is assumed that an activity of the activity group 13 to be executed in the exemplary process uses filters #1 and #2 of the filter group 14.

When a user requests execution of an activity from the UI unit 12 of the MFP 1 (step S601), the activity requests the log recording unit 17 to make preparations for log recording (step S602).

The log recording unit 17 requests the data management unit 16 to generate log data (step S603). When the log data are generated successfully, the data management unit 16 returns a generation completion report to the log recording unit 17 (step S604). When receiving the generation completion report, the log recording unit 17 returns an image processing ID to the activity (step S605). The log data generated by the data management unit 16 correspond to an activity log shown in FIG. 22A. At this stage, information is set only in the user name field and the image processing ID field of the log data. Meanwhile, at this stage, the data and time field, the result field, and the log pointer field are blank, and the flags in the log type field are set to 0.

After step S605, the activity sends initial log information (e.g. log type and date/time) to be recorded at the start of the activity together with the image processing ID to the log recording unit 17 and requests the log recording unit 17 to record the initial log information (step S606).

The log recording unit 17 sends a request for the log data to the data management unit 16 (step S607) and thereby obtains the log data (step S608). The log recording unit 17 updates the obtained log data (step S609) and then requests the data management unit 16 to store the updated log data (step S610).

After storing the updated log data, the data management unit 16 returns a storage completion report to the log recording unit 17 (step S611). Then, the log recording unit 17 returns a recording completion report to the activity (step S612). Alternatively, the MFP 1 may be configured to record the initial log information at the end of the activity together with other information. In such a case, steps S606 through S612 may be omitted.

After step S612, the activity sends the image processing ID to the filter #1 of the filter group 14 and requests the filter #1 to perform its task (sends an execution request to the filter #1) (step S613). When requested, the filter #1 performs its task (step S614). After confirming the completion of the task (step S615), the filter #1 sends filter log information to the log recording unit 17 and requests the log recording unit 17 to record the filter log information (step S616).

The log recording unit 17 sends a request for the log data to the data management unit 16 (step S617) and thereby obtains the log data (step S618). Then, the log recording unit 17 updates the obtained log data (step S619). In this step, the log recording unit 17 adds a log of the filter #1 based on the filter log information to the log data and also sets a pointer to the log of the filter #1 in the log pointer field of the activity log.

After step S619, the log recording unit 17 requests the data management unit 16 to store the updated log data (step S620). After storing the updated log data, the data management unit 16 returns a storage completion report to the log recording unit 17 (step S621). The log recording unit 17 returns a recording completion report to the filter #1 (step S622). Then, the filter #1 returns a filter completion report to the activity (step S623).

The steps to be performed for the filter #2 are substantially the same as those (steps S613 through S623) for the filter #1. Therefore, in FIG. 25, the steps to be performed for the filter #2 are simplified and represented by steps S624 through S626.

After step S626, the activity sends final log information (e.g. the result) to be recorded at the end of the activity to the log recording unit 17 and requests the log recording unit 17 to record the final log information (step S627).

The log recording unit 17 sends a request for the log data to the data management unit 16 (step S628) and thereby obtains the log data (step S629). The log recording unit 17 updates the obtained log data (step S630) and then requests the data management unit 16 to store the updated log data (step S631).

After storing the updated log data, the data management unit 16 returns a storage completion report to the log recording unit 17 (step S632). The log recording unit 17 returns a recording completion report to the activity (step S633). Then, the activity returns an activity completion report to the UI unit 12 (step S634) and terminates the process.

### SUMMARY

As described above, embodiments of the present invention provide the following advantages:

(1) In an image processing apparatus or a log recording method according to embodiments of the present invention, log formats are provided separately for an activity and filters. This configuration makes it possible to reduce the number of necessary log formats even when multiple input and output filters are usable in an activity and thereby to simplify a program for recording logs.

(2) Recording activity logs and filter logs separately makes it possible to record logs of newly-added filters without changing activities.

(3) According to an embodiment of the present invention, an image processing ID is assigned to an activity log when an activity is started, and the image processing ID is included in each of the corresponding filter logs. This configuration makes it possible to merge or link an activity log and filter logs recorded separately.

(4) Log recording settings make it possible to specify combinations of input and output filters and make it possible to determine whether to record logs based on the combinations of input and output filters by using one software component.

(5) Log recording settings make it possible to specify filters whose logs are to be recorded and make it possible to determine whether to record logs based on the specifications by using one software component.

(6) Log recording settings make it possible to specify, by user accounts, logs to be recorded and make it possible to determine whether to record logs based on the user accounts by using one software component.

(7) Log recording settings make it possible to specify, by security levels, logs to be recorded and make it possible to determine whether to record logs based on the security levels by using one software component.

(8) Log recording settings make it possible to specify, by security levels including a P2600-compliant security level, logs to be recorded and make it possible to determine whether to record logs based on the security levels by using one software component.

(9) Using a filter framework to record important logs concerning security and/or accounting makes it possible to prevent a third-party filter from being executed without recording such important logs.

(10) Since each filter log includes a filter type field, it is possible to display logs filter by filter.

(11) Merging logs of filters used in an activity while recording the logs makes it possible to speed up the process of displaying logs.

Embodiments of the present invention make it possible to efficiently record logs with a small number of log formats in an image processing apparatus where an application level function is implemented by a combination of basic functions.

In an image processing apparatus according to an embodiment of the present invention, a log of an application level function and logs of basic functions constituting the application level function are recorded separately but can be linked by, for example, an ID or pointers. This configuration makes it possible to efficiently record logs with a small number of log formats.

The present invention is not limited to the specifically disclosed embodiments, and variations and modifications may be made without departing from the scope of the present invention.

The present application is based on Japanese Priority Application No. 2006-309435 filed on Nov. 15, 2006, and Japanese Priority Application No. 2007-276732 filed on Oct. 24, 2007, the entire contents of which are hereby incorporated herein by reference.

What is claimed is:

1. An image processing apparatus where an application level function is implemented by one or more basic functions, comprising:
a log recording unit configured to record basic function logs of the basic functions according to log formats of the basic functions, the basic function logs being associated with an application level function log of the application level function.

2. The image processing apparatus as claimed in claim 1, wherein the log recording unit is configured to attach an image processing ID identifying an image processing job performed by the application level function to the application level function log and to each of the basic function logs, the basic function logs being associated with the application level function log by the image processing ID.

3. The image processing apparatus as claimed in claim 1, wherein the log recording unit is configured to store pointers to the basic function logs in the application level function log, the basic function logs being associated with the application level function log by the pointers.

4. The image processing apparatus as claimed in claim 1, further comprising:
a framework on which the basic functions operate and which is configured to record the basic function logs.

5. The image processing apparatus as claimed in claim 1, further comprising:
a user interface unit configured to provide a user interface for making log recording settings that specify a combination of the basic functions, wherein the log recording unit is configured to record the basic function logs if the basic functions are used in the combination specified in the log recording settings.

6. The image processing apparatus as claimed in claim 1, further comprising:
a user interface unit configured to provide a user interface for making log recording settings that specify the basic functions whose basic function logs are to be recorded, wherein the log recording unit is configured to record the basic function logs of the basic functions specified in the log recording settings.

7. The image processing apparatus as claimed in claim 1, further comprising:
a user interface unit configured to provide a user interface for making log recording settings that specify one or more users, wherein the log recording unit is configured to record the application level function log and the basic function logs if the application level function is executed by any one of the users specified in the log recording settings.

8. The image processing apparatus as claimed in claim 1, further comprising:
a user interface unit configured to provide a user interface for making log recording settings that define security levels, for each of which the basic functions whose basic function logs are to be recorded are specified, wherein the log recording unit is configured to determine whether to record the basic function logs according to the security levels defined in the log recording settings.

9. The image processing apparatus as claimed in claim 1, further comprising:
a log displaying unit configured to display a list of image processing logs of image processing jobs performed by the application level function, a list of the basic function logs, or details of the image processing logs or the basic function logs.

10. A method for recording logs in an image processing apparatus where an application level function is implemented by one or more basic functions, the method comprising the step of:
recording basic function logs of the basic functions according to log formats of the basic functions, the basic function logs being associated with an application level function log of the application level function.

11. The method as claimed in claim 10, further comprising the step of:
attaching an image processing ID identifying an image processing job performed by the application level function to the application level function log and to each of the basic function logs, the basic function logs being associated with the application level function log by the image processing ID.

12. The method as claimed in claim 10, further comprising the step of:
storing pointers to the basic function logs in the application level function log, the basic function logs being associated with the application level function log by the pointers.

13. The method as claimed in claim 10, wherein the basic function logs are recorded by a framework on which the basic functions operate, which framework is provided in the image processing apparatus.

14. The method as claimed in claim 10, wherein the basic function logs are recorded if the basic functions are used in a combination specified in log recording settings.

15. The method as claimed in claim 10, wherein the basic function logs are recorded if the basic functions are specified in log recording settings.

16. The method as claimed in claim 10, wherein the application level function log and the basic function logs are recorded if the application level function is executed by a user specified in log recording settings.

17. The method as claimed in claim 10, wherein whether to record the basic function logs of the basic functions is determined according to security levels defined in log recording settings, for each of which security levels the basic functions whose basic function logs are to be recorded are specified.

18. The method as claimed in claim 10, further comprising the step of:
displaying a list of image processing logs of image processing jobs performed by the application level function, a list of the basic function logs, or details of the image processing logs or the basic function logs.

19. A storage medium having program code embodied therein for causing a computer controlling an image processing apparatus, in which image processing apparatus an application level function is implemented by one or more basic functions, to record basic function logs of the basic functions according to log formats of the basic functions, the basic function logs being associated with an application level function log of the application level function.
